(19) United States
(12) Patent Application Publication
(10) Pub. No.: US 2023/0068798 A1
(43) Pub. Date: Mar. 2, 2023

(54) ACTIVE SPEAKER DETECTION USING IMAGE DATA

(71) Applicant: Amazon Technologies, Inc., Seattle, WA (US)

(72) Inventors: Tyler Jerel Etchart, Auburn, WA (US); Vivek Yadav, Lakewood, CO (US); Pradeep Natarajan, Chicago, IL (US)

(21) Appl. No.: 17/465,143

(22) Filed: Sep. 2, 2021

(51) Int. Cl. G10L 15/25; G06K 9/00; G06T 7/70; G10L 15/22; G10L 25/78

(52) U.S. Cl. CPC G10L 15/25; G06K 9/00248; G06K 9/00302; G06T 7/70; G10L 15/22; G10L 25/78; G06T 2207/30201

(57) ABSTRACT

A system can operate a speech-controlled device to perform active speaker detection to detect an utterance using image data showing a user speaking the utterance. This enables the device to perform utterance detection using the image data and/or determine which user is speaking the utterance. To perform active speaker detection, the device processes the image data to determine expression parameters associated with the user's face and generates facial measurements based on the expression parameters. For example, the device can use the expression parameters to generate a 3D model including an agnostic facial representation and determine a mouth aspect ratio by measuring a mouth height and a mouth width of the agnostic facial representation. As the mouth aspect ratio changes when the user is speaking, the device can determine that the user is speaking and/or detect an utterance based on an amount of variation of the mouth aspect ratio.

### BACKGROUND

Speech recognition systems have progressed to the point where humans can interact with computing devices using their voices. Such systems employ techniques to identify the words spoken by a human user based on the various qualities of a received audio input. Speech recognition combined with natural language understanding processing techniques enable speech-based user control of a computing device to perform tasks based on the user's spoken commands. Speech recognition and natural language understanding processing techniques may be referred to collectively or separately herein as speech processing. Speech processing may also involve converting a user's speech into text data which may then be provided to various text-based software applications.

Speech processing may be used by computers, hand-held devices, telephone computer systems, kiosks, and a wide variety of other devices to improve human-computer interactions.

### BRIEF DESCRIPTION OF DRAWINGS

For a more complete understanding of the present disclosure, reference is now made to the following description taken in conjunction with the accompanying drawings.

FIG. 1 is a conceptual diagram illustrating a virtual assistant system performing active speaker detection to detect and track an utterance, according to embodiments of the present disclosure.

FIG. 2 is a conceptual diagram of components of the system, according to embodiments of the present disclosure.

FIG. 3 is a conceptual diagram illustrating components that may be included in a device, according to embodiments of the present disclosure.

FIG. 4 is a conceptual diagram of components of a system to detect if input audio data includes system directed speech, according to embodiments of the present disclosure.

FIG. 5 is a conceptual diagram of components of an image processing component, according to embodiments of the present disclosure.

FIGS. 6A-6F illustrate examples of tracking a user's face in image data in accordance various embodiments.

FIG. 7 is a conceptual diagram illustrating an example of performing active speaker detection by calculating a mouth aspect ratio, according to embodiments of the present disclosure.

FIGS. 8A-8B are conceptual diagrams illustrating example of generating a mesh model having an agnostic facial representation, according to embodiments of the present disclosure.

FIG. 9 is a conceptual diagram illustrating an example of shape parameters and expression parameters used to generate a mesh model, according to embodiments of the present disclosure.

FIGS. 10A-10B are conceptual diagrams illustrating examples of performing facial measurements and calculating aspect ratios, according to embodiments of the present disclosure.

FIG. 11 is a conceptual diagram illustrating examples of mouth aspect ratio values and corresponding standard deviations associated with two different faces, according to embodiments of the present disclosure.

FIG. 12A is a conceptual diagram illustrating an example of a frame-based method for performing active speaker detection, according to embodiments of the present disclosure.

FIG. 12B is a conceptual diagram illustrating an example of an utterance-based method for performing active speaker detection, according to embodiments of the present disclosure.

FIG. 13 is a flowchart conceptually illustrating an example method for generating mouth aspect ratio data, according to embodiments of the present disclosure.

FIG. 14A is a flowchart conceptually illustrating an example of a frame-based method for performing active speaker detection to detect an utterance, according to embodiments of the present disclosure.

FIG. 14B is a flowchart conceptually illustrating an example of an utterance-based method for performing active speaker detection to identify a face associated with an utterance, according to embodiments of the present disclosure.

FIGS. 15A-15B are flowcharts conceptually illustrating example methods for determining mouth data and using the mouth data to determine whether a user is speaking, according to embodiments of the present disclosure.

FIGS. 16A-16B are flowcharts conceptually illustrating example methods for performing active speaker detection to detect an utterance and perform speech processing, according to embodiments of the present disclosure.

FIG. 17 is a flowchart conceptually illustrating an example method for performing active speaker detection to determine which user is speaking and perform an action, according to embodiments of the present disclosure.

FIG. 18 is a block diagram conceptually illustrating example components of a device, according to embodiments of the present disclosure.

FIG. 19 is a block diagram conceptually illustrating example components of a system, according to embodiments of the present disclosure.

FIG. 20 illustrates an example of a computer network for use with the overall system, according to embodiments of the present disclosure.

### DETAILED DESCRIPTION

An electronic device can leverage different computerized voice-enabled technologies. Automatic speech recognition (ASR) is a field of computer science, artificial intelligence, and linguistics concerned with transforming audio data associated with speech into text representative of that speech. Similarly, natural language understanding (NLU) is a field of computer science, artificial intelligence, and linguistics concerned with enabling computers to derive meaning from text input containing natural language. ASR and NLU are often used together as part of a speech processing system, sometimes referred to as a spoken language understanding (SLU) system. Text-to-speech (TTS) is a field of computer science concerning transforming textual and/or other data into audio data that is synthesized to resemble human speech. ASR, NLU, and TTS may be used together as part of a speech-processing system.

The system may be configured to incorporate user permissions and may only perform activities disclosed herein if approved by a user. As such, the systems, devices, components, and techniques described herein would be typically configured to restrict processing where appropriate and only process user information in a manner that ensures compliance with all appropriate laws, regulations, standards, and the like. The system and techniques can be implemented on a geographic basis to ensure compliance with laws in various jurisdictions and entities in which the components of the system and/or user are located.

Dialog processing is a field of computer science that involves communication between a computing system and a human via text, audio, and/or other forms of communication. While some dialog processing involves only simple generation of a response given only a most recent input from a user (i.e., single-turn dialog), more complicated dialog processing involves determining and optionally acting on one or more goals expressed by the user over multiple turns of dialog, such as making a restaurant reservation and/or booking an airline ticket. These multi-turn “goal-oriented” dialog systems typically need to recognize, retain, and use information collected during more than one input during a back-and-forth or “multi-turn” interaction with the user.

To improve dialog processing and/or a user experience, a system may be configured to use image data to help perform active speaker detection to detect/understand an utterance and/or determine which user is speaking. When performing utterance detection, for example, the system may be configured to process input image data in order to respond accordingly. For example, the system may continuously process image data to identify a face represented in the image data, perform facial analysis to determine shape parameters (e.g., data representing a face shape or at least relative positioning of particular facial features with respect to other facial features) and facial expression parameters (e.g., data representing a facial expression or at least relative movement of facial features) representing the face, and use the expression parameters to determine whether the user is speaking. In some examples, the system uses the expression parameters to generate a neutral mesh model with uniform identity and pose that represents the user's mouth movements. Using the neutral mesh model, the system may measure the user's mouth movements over time, such as by determining a mouth aspect ratio between a mouth height and a mouth width. Based on an amount of variation in the mouth movements, the system can determine whether the user is speaking and detect an utterance.

In some examples, the system may be configured to process audio data to detect an utterance and determine a beginning and/or ending of the utterance. To improve a user experience, the system may perform active speaker detection to determine which user is speaking based on the image data. Using the techniques described above, the system may process a portion of the image data corresponding to the utterance to determine an amount of variation in mouth movements for each face represented in the image data. For example, the system may compare a first amount of variation associated with a first user to a second amount of variation associated with a second user in order to determine whether the first user is speaking or the second user is speaking.

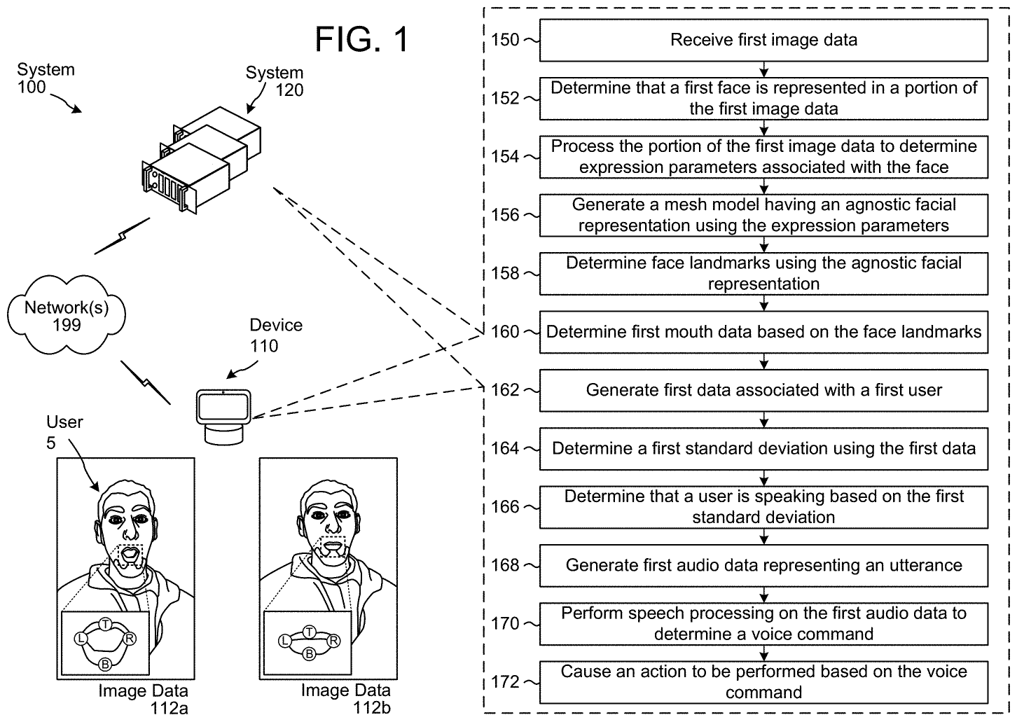

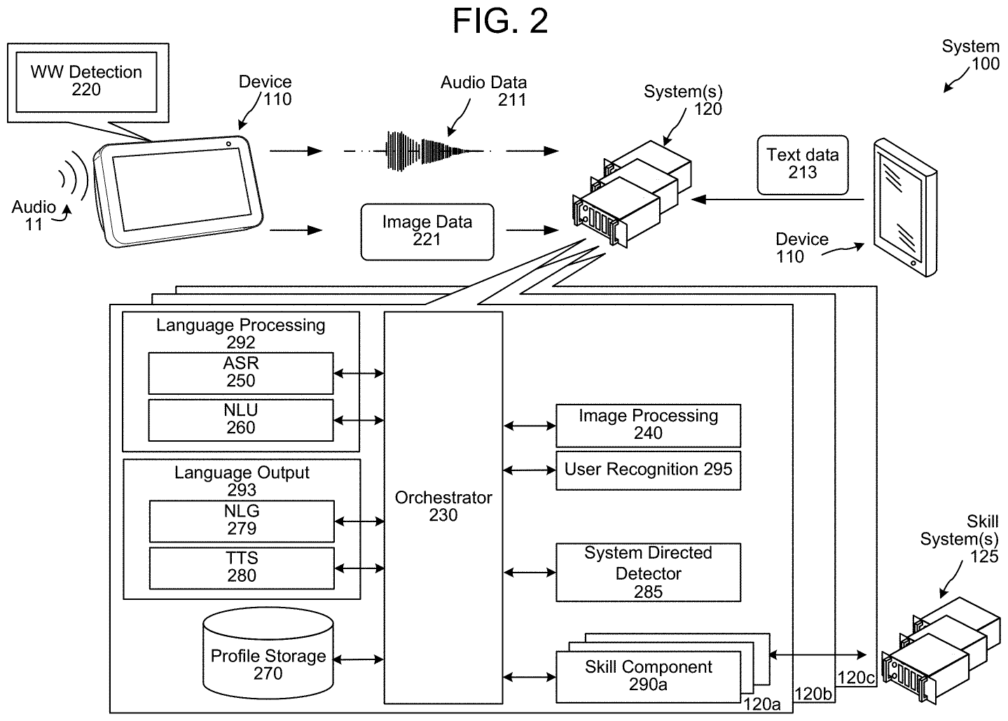

FIG. 1 is a conceptual diagram illustrating a virtual assistant system performing active speaker detection to detect and track an utterance according to embodiments of the present disclosure. As shown in FIG. 1, the virtual assistant system 100 may include a voice-enabled device 110 local to a user 5, a natural language command processing system 120 (abbreviated “system 120”), and one or more skill support systems 125 (shown in FIG. 2) connected across one or more networks 199. Although the figures and discussion of the present disclosure illustrate certain steps in a particular order, the steps described may be performed in a different order (as well as certain steps removed or added) without departing from the present disclosure.

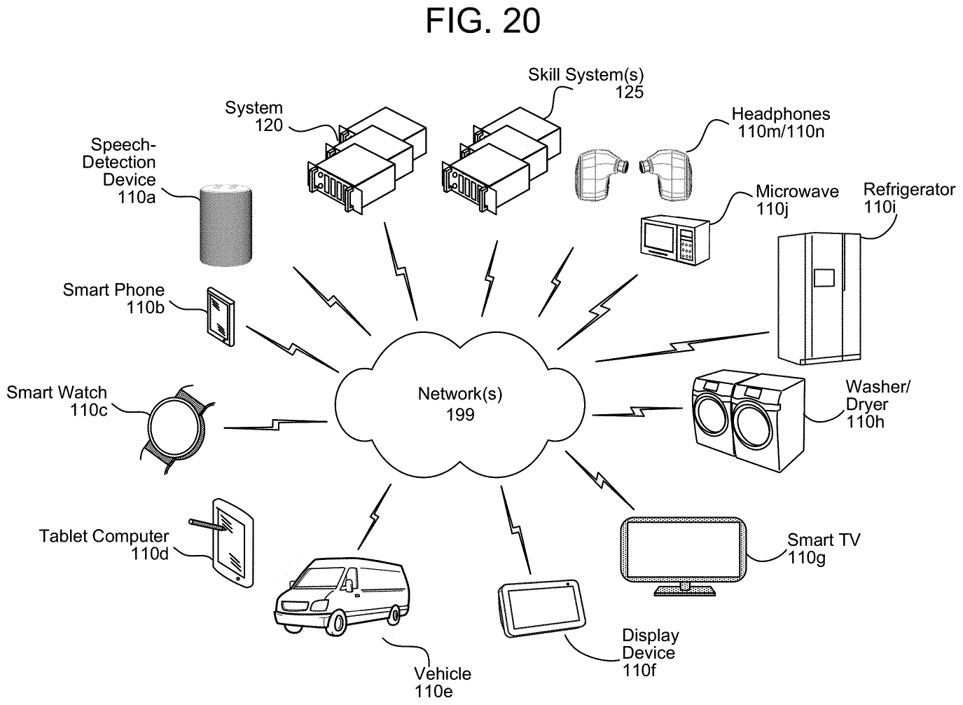

The device 110 may receive audio corresponding to a spoken natural language input originating from the user 5. In some examples, the device 110 may process audio following detection of a wakeword. The device 110 may generate audio data 211 corresponding to the audio, and may send the audio data 211 to the system 120. The device 110 may send the audio data 211 to the system 120 via an application that is installed on the device 110 and associated with the system 120. An example of such an application is the Amazon Alexa application that may be installed on a smart phone, tablet, or the like. In some implementations, the device 110 may receive text data 213 corresponding to a natural language input originating from the user 5, and send the text data to the system 120. The device 110 may also receive output data from the system 120, and generate a synthesized speech output. The device 110 may include a camera for capturing image and/or video data for processing by the system 120, which is collectively referred to as image data 112. Examples of various devices 110 are further illustrated in FIG. 20. The system 120 may be remote system such as a group of computing components located geographically remote from device 110 but accessible via network 199 (for example, servers accessible via the internet). The system 120 may also include a remote system that is physically separate from device 110 but located geographically close to device 110 and accessible via network 199 (for example a home server located in a same residence as device 110. System 120 may also include some combination thereof, for example where certain components/operations are performed via a home server(s) and others are performed via a geographically remote server(s).

To improve a user experience, the system 100 may be configured to perform active speaker detection to detect an utterance using image data. Instead of processing the audio data 211 to perform utterance detection, the system 100 may be configured to process the image data 112 in order to identify when a user is speaking to the system and respond accordingly. For example, the system 100 may continuously process the image data 112 to identify a face of the user 5 represented in the image data, perform facial analysis to determine shape parameters (e.g., data representing a face shape or at least relative positioning of particular facial features with respect to other facial features) and facial expression parameters (e.g., data representing a facial expression or at least relative movement of facial features) representing the user's face, and use the expression parameters to determine whether the user 5 is speaking. In some examples, the system 100 uses the expression parameters to generate a neutral mesh model having agnostic facial representation with uniform identity and pose that represents the user's mouth movements. Using the neutral mesh model, the system 100 may measure the user's mouth movements over time, such as by determining a mouth aspect ratio between a mouth height and a mouth width. Based on an amount of variation in the mouth movements, the system 100 can determine whether the user is speaking and detect an utterance.

In other examples, the system 100 may be configured to process the audio data 211 to detect an utterance and determine a beginning and/or ending of the utterance. To improve a user experience, the system 100 may perform active speaker detection to determine which user is speaking based on the image data. Using the techniques described above, the system 100 may process a portion of the image data 112 corresponding to the utterance (e.g., within a selected time window based on the beginning and/or ending of the utterance) to determine an amount of variation in mouth movements for each face represented in the image data. For example, the system 100 may compare a first amount of variation associated with a first user to a second amount of variation associated with a second user in order to determine whether the first user is speaking or the second user is speaking.

The system 100 may use computer vision (CV) techniques operating on image data to perform active speaker detection. The system 100 may thus use image data to determine when a user 5 is speaking and/or which user is speaking. The system 100 may use face detection techniques to detect a human face represented in image data (for example using object detection component 530 as discussed below). The system 100 may use a classifier or other model configured to determine whether a face is looking at a device 110 (for example using object tracking component 560 as discussed below). The system 100 may also be configured to track a face in image data to understand which faces in the video are belonging to the same person and where they may be located in image data and/or relative to a device 110 (for example using user recognition component 295 and/or object tracking component 560 as discussed below). The system 100 may also be configured to determine an active speaker, for example by determining which face(s) in image data belong to the same person and whether the person is speaking or not (for example using image data of a user's lips to see if they are moving and matching such image data to data regarding a user's voice and/or audio data of speech and whether the words of the speech match the lip movement). The system 100 may use components such as user recognition component 295, object tracking component 560, and/or other components to perform such operations.

As illustrated in FIG. 1, a system 100, through device 110/remote system 120, may receive (150) first image data generated by a camera of the device 110, may determine (152) that a first face is represented in a portion of the first image data, and may process (154) the portion of the first image data to determine expression parameters (e.g., facial expression parameters) corresponding to the first face. As described in greater detail below, the system 100 may process the portion of the first image data using a deep neural network (DNN) or other trained model that is configured to generate 3D Morphable Model (3DMM) parameters that include at least the expression parameters along with other parameters, such as shape parameters. However, the disclosure is not limited thereto and in some examples the system 100 may input the first image data to the DNN or other trained model without departing from the disclosure.

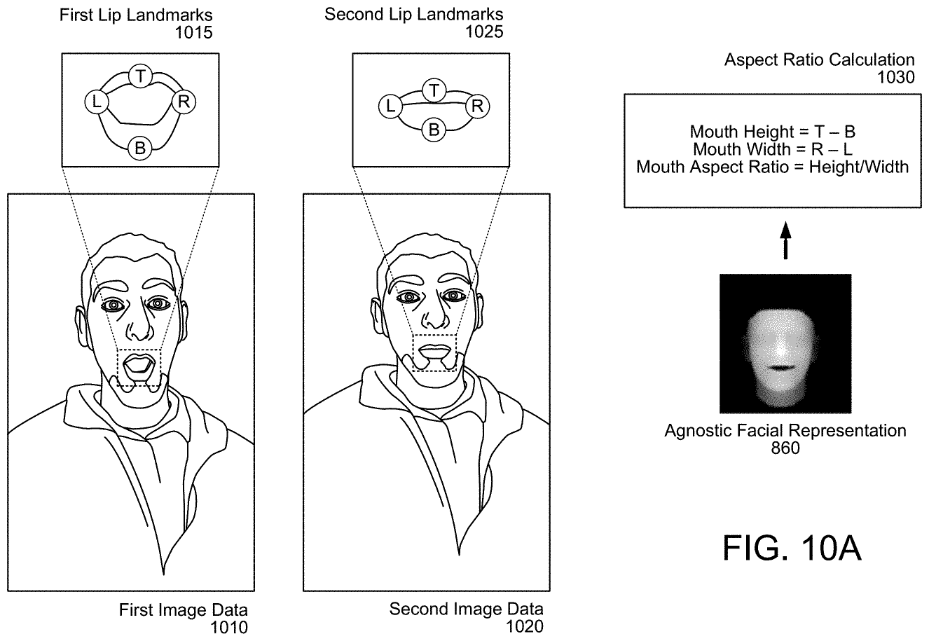

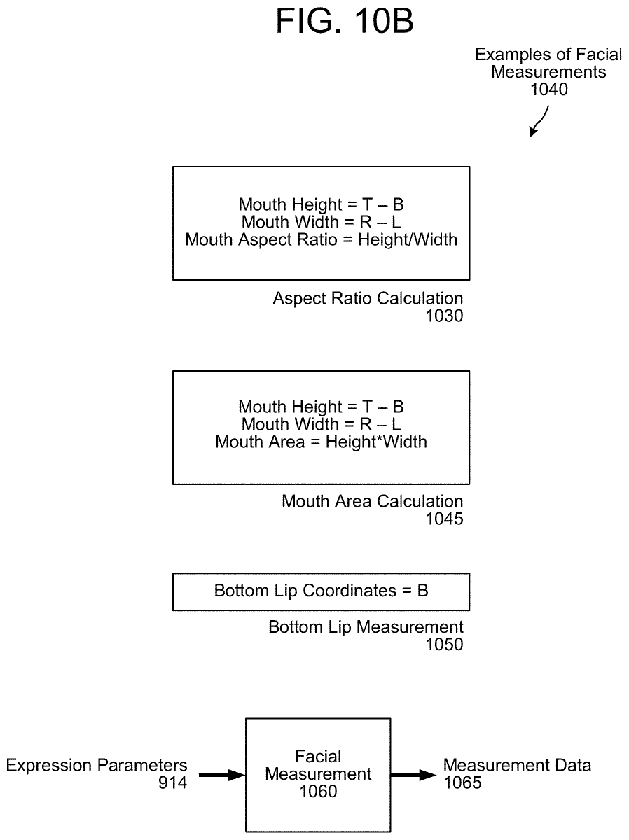

Using the expression parameters, the system 100 may generate (156) a mesh model having an agnostic facial representation and may determine (158) face landmarks using the agnostic facial representation. For example, the system 100 may generate a mesh model representing the face using only the expression parameters (e.g., ignoring the shape parameters and other portions of the 3DMM parameters) and may determine coordinate values corresponding to the face landmarks within the mesh model, as described below with regard to FIG. 10A. After determining the face landmarks and corresponding coordinate values, the system 100 may determine (160) first mouth data based on the face landmarks. In some examples, the first mouth data may represent a mouth aspect ratio of the agnostic facial representation, although the disclosure is not limited thereto. For example, the system 100 may determine a first distance corresponding to a mouth height, a second distance corresponding to a mouth width, and determine the mouth aspect ratio value by dividing the first distance by the second distance. However, the disclosure is not limited thereto and the system 100 may determine the mouth aspect ratio and/or other facial measurements using other techniques without departing from the disclosure.

The system 100 may generate (162) first data associated with the first user. For example, the system 100 may generate the first data by combining the first mouth data generated at a first time with second mouth data generated a second time and/or the like. Thus, the first data may correspond to a series of mouth aspect ratio values for the first user over time, although the disclosure is not limited thereto. The system 100 may determine (164) a first standard deviation using the first data. For example, the system 100 may process the series of mouth aspect ratio values and determine the first standard deviation value representing an amount of variation represented in the series of mouth aspect ratio values. However, the disclosure is not limited thereto and the system 100 may determine the standard deviation using other techniques without departing from the disclosure. For example, the system 100 may take difference values between mouth aspect ratio values over time and determine the first standard deviation value based on these difference values without departing from the disclosure.

The system 100 may determine (166) that a user is speaking based on the first standard deviation. For example, the system 100 may determine that the user is speaking when the first standard deviation satisfies a threshold. In some examples, the system 100 may select a threshold value based on test data, such that the threshold value corresponds to a strong likelihood that the user is speaking. However, the disclosure is not limited thereto, and in other examples the system 100 may select the threshold based on a second standard deviation associated with a second user without departing from the disclosure. Thus, the system 100 may determine that the first user is more likely to be speaking than the second user, although the disclosure is not limited thereto.

When the system 100 determines that the user is speaking (e.g., detects an utterance), the system 100 may generate (168) first audio data representing the utterance, may perform (170) speech processing on the first audio data to determine a voice command, and may cause an action to be performed based on the voice command.

The system 100 may operate using various components as described in FIG. 2. The various components may be located on same or different physical devices. Communication between various components may occur directly or across a network(s) 199. The device 110 may include audio capture component(s), such as a microphone or array of microphones of a device 110, captures audio 11 and creates corresponding audio data. Once speech is detected in audio data representing the audio 11, the device 110 may determine if the speech is directed at the device 110/system 120. In at least some embodiments, such determination may be made using a wakeword detection component 220. The wakeword detection component 220 may be configured to detect various wakewords. In at least some examples, each wakeword may correspond to a name of a different digital assistant. An example wakeword/digital assistant name is “Alexa.” In another example, input to the system may be in form of text data 213, for example as a result of a user typing an input into a user interface of device 110. Other input forms may include indication that the user has pressed a physical or virtual button on device 110, the user has made a gesture, etc. The device 110 may also capture images using camera(s) 1818 of the device 110 and may send image data 112 representing those image(s) to the system 120. The image data 112 may include raw image data or image data processed by the device 110 before sending to the system 120. The image data 112 may also include individual still images and/or a video feed of multiple images.

The wakeword detector 220 of the device 110 may process the audio data, representing the audio 11, to determine whether speech is represented therein. The device 110 may use various techniques to determine whether the audio data includes speech. In some examples, the device 110 may apply voice-activity detection (VAD) techniques. Such techniques may determine whether speech is present in audio data based on various quantitative aspects of the audio data, such as the spectral slope between one or more frames of the audio data; the energy levels of the audio data in one or more spectral bands; the signal-to-noise ratios of the audio data in one or more spectral bands; or other quantitative aspects. In other examples, the device 110 may implement a classifier configured to distinguish speech from background noise. The classifier may be implemented by techniques such as linear classifiers, support vector machines, and decision trees. In still other examples, the device 110 may apply hidden Markov model (HMM) or Gaussian mixture model (GMM) techniques to compare the audio data to one or more acoustic models in storage, which acoustic models may include models corresponding to speech, noise (e.g., environmental noise or background noise), or silence. Still other techniques may be used to determine whether speech is present in audio data.

Wakeword detection is typically performed without performing linguistic analysis, textual analysis, or semantic analysis. Instead, the audio data, representing the audio 11, is analyzed to determine if specific characteristics of the audio data match preconfigured acoustic waveforms, audio signatures, or other data corresponding to a wakeword.

Thus, the wakeword detection component 220 may compare audio data to stored data to detect a wakeword. One approach for wakeword detection applies general large vocabulary continuous speech recognition (LVCSR) systems to decode audio signals, with wakeword searching being conducted in the resulting lattices or confusion networks. Another approach for wakeword detection builds HMMs for each wakeword and non-wakeword speech signals, respectively. The non-wakeword speech includes other spoken words, background noise, etc. There can be one or more HMMs built to model the non-wakeword speech characteristics, which are named filler models. Viterbi decoding is used to search the best path in the decoding graph, and the decoding output is further processed to make the decision on wakeword presence. This approach can be extended to include discriminative information by incorporating a hybrid DNN-HMM decoding framework. In another example, the wakeword detection component 220 may be built on deep neural network (DNN)/recursive neural network (RNN) structures directly, without HMM being involved. Such an architecture may estimate the posteriors of wakewords with context data, either by stacking frames within a context window for DNN, or using RNN. Follow-on posterior threshold tuning or smoothing is applied for decision making. Other techniques for wakeword detection, such as those known in the art, may also be used.

Once the wakeword is detected by the wakeword detector 220 and/or input is detected by an input detector, the device 110 may “wake” and begin transmitting audio data 211, representing the audio 11, to the system(s) 120. The audio data 211 may include data corresponding to the wakeword; in other embodiments, the portion of the audio corresponding to the wakeword is removed by the device 110 prior to sending the audio data 211 to the system(s) 120. In the case of touch input detection or gesture based input detection, the audio data may not include a wakeword.

In some implementations, the system 100 may include more than one system 120. The systems 120 may respond to different wakewords and/or perform different categories of tasks. Each system 120 may be associated with its own wakeword such that speaking a certain wakeword results in audio data be sent to and processed by a particular system. For example, detection of the wakeword “Alexa” by the wakeword detector 220 may result in sending audio data to system 120a for processing while detection of the wakeword “Computer” by the wakeword detector may result in sending audio data to system 120b for processing. The system may have a separate wakeword and system for different skills/systems (e.g., “Dungeon Master” for a game play skill/system 120c) and/or such skills/systems may be coordinated by one or more skill(s) 290 of one or more systems 120.

Upon receipt by the system(s) 120, the audio data 211 may be sent to an orchestrator component 230. The orchestrator component 230 may include memory and logic that enables the orchestrator component 230 to transmit various pieces and forms of data to various components of the system, as well as perform other operations as described herein.

The orchestrator component 230 may send the audio data 211 to a language processing component 292. The language processing component 292 (sometimes also referred to as a spoken language understanding (SLU) component) includes an automatic speech recognition (ASR) component 250 and a natural language understanding (NLU) component 260. The ASR component 250 may transcribe the audio data 211 into text data. The text data output by the ASR component 250 represents one or more than one (e.g., in the form of an N-best list) ASR hypotheses representing speech represented in the audio data 211. The ASR component 250 interprets the speech in the audio data 211 based on a similarity between the audio data 211 and pre-established language models. For example, the ASR component 250 may compare the audio data 211 with models for sounds (e.g., acoustic units such as phonemes, senons, phones, etc.) and sequences of sounds to identify words that match the sequence of sounds of the speech represented in the audio data 211. The ASR component 250 sends the text data generated thereby to an NLU component 260, via, in some embodiments, the orchestrator component 230. The text data sent from the ASR component 250 to the NLU component 260 may include a single top-scoring ASR hypothesis or may include an N-best list including multiple top-scoring ASR hypotheses. An N-best list may additionally include a respective score associated with each ASR hypothesis represented therein.

The speech processing system 292 may further include a NLU component 260. The NLU component 260 may receive the text data from the ASR component. The NLU component 260 may attempts to make a semantic interpretation of the phrase(s) or statement(s) represented in the text data input therein by determining one or more meanings associated with the phrase(s) or statement(s) represented in the text data. The NLU component 260 may determine an intent representing an action that a user desires be performed and may determine information that allows a device (e.g., the device 110, the system(s) 120, a skill component 290, a skill system(s) 125, etc.) to execute the intent. For example, if the text data corresponds to “play the 5^{th} Symphony by Beethoven,” the NLU component 260 may determine an intent that the system output music and may identify “Beethoven” as an artist/composer and “5th Symphony” as the piece of music to be played. For further example, if the text data corresponds to “what is the weather,” the NLU component 260 may determine an intent that the system output weather information associated with a geographic location of the device 110. In another example, if the text data corresponds to “turn off the lights,” the NLU component 260 may determine an intent that the system turn off lights associated with the device 110 or the user 5. However, if the NLU component 260 is unable to resolve the entity—for example, because the entity is referred to by anaphora/a contextual reference such as “this song” or “my next appointment”—the speech processing system 292 can send a decode request to another speech processing system 292 for information regarding the entity mention and/or other context related to the utterance. The speech processing system 292 may augment, correct, or base results data upon the audio data 211 as well as any data received from the other speech processing system 292.

The NLU component 260 may return NLU results data 985/925 (which may include tagged text data, indicators of intent, etc.) back to the orchestrator 230. The orchestrator 230 may forward the NLU results data to a skill component(s) 290. If the NLU results data includes a single NLU hypothesis, the NLU component 260 and the orchestrator component 230 may direct the NLU results data to the skill component(s) 290 associated with the NLU hypothesis. If the NLU results data 985/925 includes an N-best list of NLU hypotheses, the NLU component 260 and the orchestrator component 230 may direct the top scoring NLU hypothesis to a skill component(s) 290 associated with the top scoring NLU hypothesis

A skill component may be software running on the system(s) 120 that is akin to a software application. That is, a skill component 290 may enable the system(s) 120 to execute specific functionality in order to provide data or produce some other requested output. As used herein, a “skill component” may refer to software that may be placed on a machine or a virtual machine (e.g., software that may be launched in a virtual instance when called). A skill component may be software customized to perform one or more actions as indicated by a business entity, device manufacturer, user, etc. What is described herein as a skill component may be referred to using many different terms, such as an action, bot, app, or the like. The system(s) 120 may be configured with more than one skill component 290. For example, a weather service skill component may enable the system(s) 120 to provide weather information, a car service skill component may enable the system(s) 120 to book a trip with respect to a taxi or ride sharing service, a restaurant skill component may enable the system(s) 120 to order a pizza with respect to the restaurant's online ordering system, etc. A skill component 290 may operate in conjunction between the system(s) 120 and other devices, such as the device 110, in order to complete certain functions. Inputs to a skill component 290 may come from speech processing interactions or through other interactions or input sources. A skill component 290 may include hardware, software, firmware, or the like that may be dedicated to a particular skill component 290 or shared among different skill components 290.

A skill support system(s) 125 may communicate with a skill component(s) 290 within the system(s) 120 and/or directly with the orchestrator component 230 or with other components. A skill support system(s) 125 may be configured to perform one or more actions. An ability to perform such action(s) may sometimes be referred to as a “skill.” That is, a skill may enable a skill support system(s) 125 to execute specific functionality in order to provide data or perform some other action requested by a user. For example, a weather service skill may enable a skill support system(s) 125 to provide weather information to the system(s) 120, a car service skill may enable a skill support system(s) 125 to book a trip with respect to a taxi or ride sharing service, an order pizza skill may enable a skill support system(s) 125 to order a pizza with respect to a restaurant's online ordering system, etc. Additional types of skills include home automation skills (e.g., skills that enable a user to control home devices such as lights, door locks, cameras, thermostats, etc.), entertainment device skills (e.g., skills that enable a user to control entertainment devices such as smart televisions), video skills, flash briefing skills, as well as custom skills that are not associated with any pre-configured type of skill.

The system(s) 120 may be configured with a skill component 290 dedicated to interacting with the skill support system(s) 125. Unless expressly stated otherwise, reference to a skill, skill device, or skill component may include a skill component 290 operated by the system(s) 120 and/or skill operated by the skill support system(s) 125. Moreover, the functionality described herein as a skill or skill may be referred to using many different terms, such as an action, bot, app, or the like. The skill 290 and or skill support system(s) 125 may return output data to the orchestrator 230.

The system(s) 100 may include a dialog manager component that manages and/or tracks a dialog between a user and a device. As used herein, a “dialog” may refer to data transmissions (such as relating to multiple user inputs and system 100 outputs) between the system 100 and a user (e.g., through device(s) 110) that all relate to a single “conversation” between the system and the user that may have originated with a single user input initiating the dialog. Thus, the data transmissions of a dialog may be associated with a same dialog identifier, which may be used by components of the overall system 100 to track information across the dialog. Subsequent user inputs of the same dialog may or may not start with speaking of a wakeword. Each natural language input of a dialog may be associated with a different natural language input identifier such that multiple natural language input identifiers may be associated with a single dialog identifier. Further, other non-natural language inputs (e.g., image data, gestures, button presses, etc.) may relate to a particular dialog depending on the context of the inputs. For example, a user may open a dialog with the system 100 to request a food delivery in a spoken utterance and the system may respond by displaying images of food available for order and the user may speak a response (e.g., “item 1” or “that one”) or may gesture a response (e.g., point to an item on the screen or give a thumbs-up) or may touch the screen on the desired item to be selected. Non-speech inputs (e.g., gestures, screen touches, etc.) may be part of the dialog and the data associated therewith may be associated with the dialog identifier of the dialog.

The dialog manager component may associate a dialog session identifier with the dialog upon identifying that the user is engaging in a dialog with the user. The dialog manager component may track a user input and the corresponding system generated response to the user input as a turn. The dialog session identifier may correspond to multiple turns of user input and corresponding system generated response. The dialog manager component may transmit data identified by the dialog session identifier directly to the orchestrator component 230 or other component. Depending on system configuration the dialog manager may determine the appropriate system generated response to give to a particular utterance or user input of a turn. Or creation of the system generated response may be managed by another component of the system (e.g., the language output component 293, NLG 279, orchestrator 230, etc.) while the dialog manager selects the appropriate responses. Alternatively, another component of the system(s) 120 may select responses using techniques discussed herein. The text of a system generated response may be sent to a TTS component 280 for creation of audio data corresponding to the response. The audio data may then be sent to a user device (e.g., device 110) for ultimate output to the user. Alternatively (or in addition) a dialog response may be returned in text or some other form.

The dialog manager may receive the ASR hypothesis/hypotheses (i.e., text data) and make a semantic interpretation of the phrase(s) or statement(s) represented therein. That is, the dialog manager determines one or more meanings associated with the phrase(s) or statement(s) represented in the text data based on words represented in the text data. The dialog manager determines a goal corresponding to an action that a user desires be performed as well as pieces of the text data that allow a device (e.g., the device 110, the system(s) 120, a skill 290, a skill system(s) 125, etc.) to execute the intent. If, for example, the text data corresponds to “what is the weather,” the dialog manager may determine that that the system(s) 120 is to output weather information associated with a geographic location of the device 110. In another example, if the text data corresponds to “turn off the lights,” the dialog manager may determine that the system(s) 120 is to turn off lights associated with the device(s) 110 or the user(s) 5.

The dialog manager may send the results data to one or more skill(s) 290. If the results data includes a single hypothesis, the orchestrator component 230 may send the results data to the skill(s) 290 associated with the hypothesis. If the results data includes an N-best list of hypotheses, the orchestrator component 230 may send the top scoring hypothesis to a skill(s) 290 associated with the top scoring hypothesis.

The system 120 includes a language output component 293. The language output component 293 includes a natural language generation (NLG) component 279 and a text-to-speech (TTS) component 280. The NLG component 279 can generate text for purposes of TTS output to a user. For example the NLG component 279 may generate text corresponding to instructions corresponding to a particular action for the user to perform. The NLG component 279 may generate appropriate text for various outputs as described herein. The NLG component 279 may include one or more trained models configured to output text appropriate for a particular input. The text output by the NLG component 279 may become input for the TTS component 280 (e.g., output text data 2110 discussed below). Alternatively or in addition, the TTS component 280 may receive text data from a skill 290 or other system component for output.

The NLG component 279 may include a trained model. The NLG component 279 generates text data 2110 from dialog data received by the dialog manager such that the output text data 2110 has a natural feel and, in some embodiments, includes words and/or phrases specifically formatted for a requesting individual. The NLG may use templates to formulate responses. And/or the NLG system may include models trained from the various templates for forming the output text data 2110. For example, the NLG system may analyze transcripts of local news programs, television shows, sporting events, or any other media program to obtain common components of a relevant language and/or region. As one illustrative example, the NLG system may analyze a transcription of a regional sports program to determine commonly used words or phrases for describing scores or other sporting news for a particular region. The NLG may further receive, as inputs, a dialog history, an indicator of a level of formality, and/or a command history or other user history such as the dialog history.

The NLG system may generate dialog data based on one or more response templates. Further continuing the example above, the NLG system may select a template in response to the question, “What is the weather currently like?” of the form: “The weather currently is $weather_information$.” The NLG system may analyze the logical form of the template to produce one or more textual responses including markups and annotations to familiarize the response that is generated. In some embodiments, the NLG system may determine which response is the most appropriate response to be selected. The selection may, therefore, be based on past responses, past questions, a level of formality, and/or any other feature, or any other combination thereof. Responsive audio data representing the response generated by the NLG system may then be generated using the text-to-speech component 280.

The TTS component 280 may generate audio data (e.g., synthesized speech) from text data using one or more different methods. Text data input to the TTS component 280 may come from a skill component 290, the orchestrator component 230, or another component of the system. In one method of synthesis called unit selection, the TTS component 280 matches text data against a database of recorded speech. The TTS component 280 selects matching units of recorded speech and concatenates the units together to form audio data. In another method of synthesis called parametric synthesis, the TTS component 280 varies parameters such as frequency, volume, and noise to create audio data including an artificial speech waveform. Parametric synthesis uses a computerized voice generator, sometimes called a vocoder.

The device 110 may include still image and/or video capture components such as a camera or cameras to capture one or more images. The device 110 may include circuitry for digitizing the images and/or video for transmission to the system(s) 120 as image data. The device 110 may further include circuitry for voice command-based control of the camera, allowing a user 5 to request capture of image or video data. The device 110 may process the commands locally or send audio data 211 representing the commands to the system(s) 120 for processing, after which the system(s) 120 may return output data that can cause the device 110 to engage its camera.

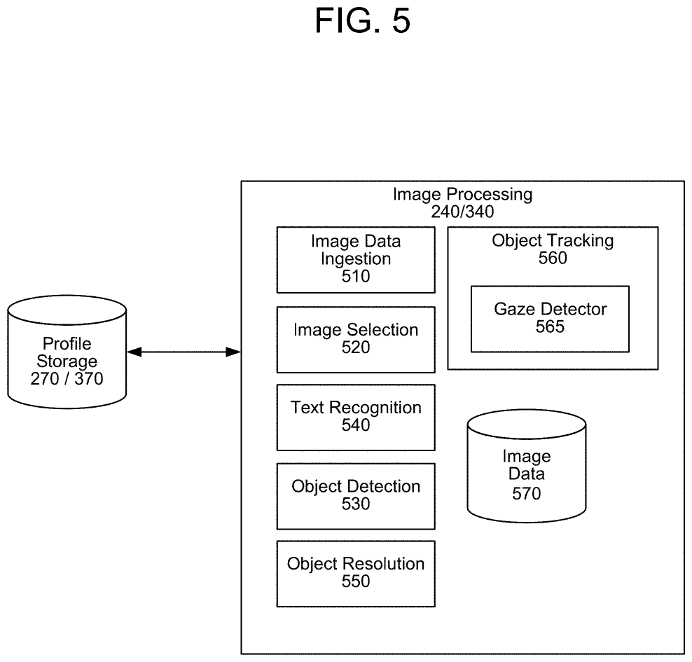

Upon receipt by the system(s) 120, the image data 112 may be sent to an orchestrator component 230. The orchestrator component 230 may send the image data 112 to an image processing component 240. The image processing component 240 can perform computer vision functions such as object recognition, modeling, reconstruction, etc. For example, the image processing component 240 may detect a person, face, etc. (which may then be identified using user recognition component 295). The image processing component 240 is described in greater detail below with regard to FIG. 5. The device 110 may also include an image processing component 340 which operates similarly to image processing component 240.

In some implementations, the image processing component 240 can detect the presence of text in an image. In such implementations, the image processing component 240 can recognize the presence of text, convert the image data to text data, and send the resulting text data via the orchestrator component 230 to the language processing component 292 for processing by the NLU component 260.

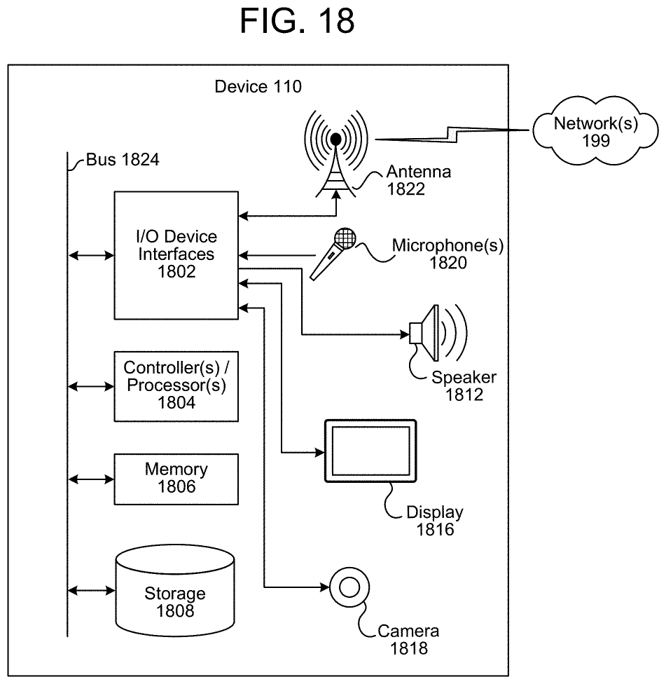

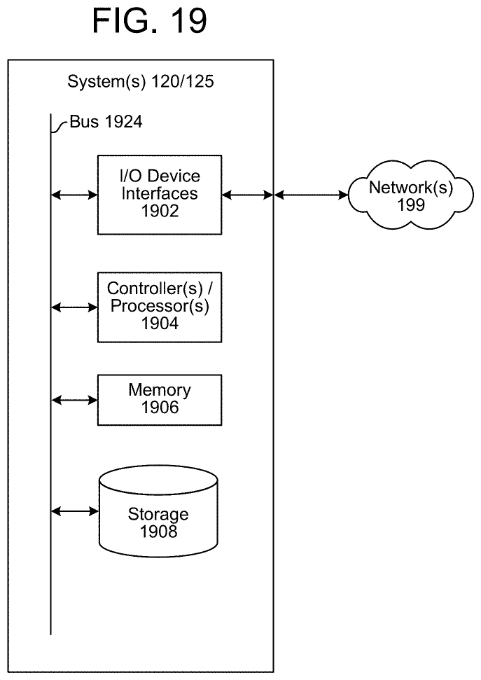

The system(s) 120 may include a user recognition component 295 that recognizes one or more users using a variety of data, as described in greater detail below with regard to FIGS. 18-19. However, the disclosure is not limited thereto, and the device 110 may include a user recognition component 395 instead of and/or in addition to user recognition component 295 of the system(s) 120 without departing from the disclosure. User recognition component 395 operates similarly to user recognition component 295.

The user recognition component 295 may take as input the audio data 211 and/or text data output by the ASR component 250. The user recognition component 295 may perform user recognition by comparing audio characteristics in the audio data 211 to stored audio characteristics of users. The user recognition component 295 may also perform user recognition by comparing biometric data (e.g., fingerprint data, iris data, etc.), received by the system in correlation with the present user input, to stored biometric data of users assuming user permission and previous authorization. The user recognition component 295 may further perform user recognition by comparing image data (e.g., including a representation of at least a feature of a user), received by the system in correlation with the present user input, with stored image data including representations of features of different users. The user recognition component 295 may perform additional user recognition processes, including those known in the art.

The user recognition component 295 determines scores indicating whether user input originated from a particular user. For example, a first score may indicate a likelihood that the user input originated from a first user, a second score may indicate a likelihood that the user input originated from a second user, etc. The user recognition component 295 also determines an overall confidence regarding the accuracy of user recognition operations. The user recognition component 295 may also be configured to determine (or assist another component in determining) that a particular voice matches a particular face for purposes of user identification and/or following a user in an environment if the user is not visible in image data).

Output of the user recognition component 295 may include a single user identifier corresponding to the most likely user that originated the user input. Alternatively, output of the user recognition component 295 may include an N-best list of user identifiers with respective scores indicating likelihoods of respective users originating the user input. The output of the user recognition component 295 may be used to inform NLU processing as well as processing performed by other components of the system.

The system 100 (either on device 110, system 120, or a combination thereof) may include profile storage for storing a variety of information related to individual users, groups of users, devices, etc. that interact with the system. As used herein, a “profile” refers to a set of data associated with a user, group of users, device, etc. The data of a profile may include preferences specific to the user, device, etc.; input and output capabilities of the device; internet connectivity information; user bibliographic information; subscription information, as well as other information.

The profile storage 270 may include one or more user profiles, with each user profile being associated with a different user identifier/user profile identifier. Each user profile may include various data 271 (not illustrated separately) corresponding to a user/group of the profile. Each user profile may also include data corresponding to preferences of the user. Each user profile may also include preferences of the user and/or one or more device identifiers, representing one or more devices of the user. For instance, the user account may include one or more IP addresses, MAC addresses, and/or device identifiers, such as a serial number, of each additional electronic device associated with the identified user account. When a user logs into to an application installed on a device 110, the user profile (associated with the presented login information) may be updated to include information about the device 110, for example with an indication that the device is currently in use. Each user profile may include identifiers of skills that the user has enabled. When a user enables a skill, the user is providing the system 120 with permission to allow the skill to execute with respect to the user's natural language user inputs. If a user does not enable a skill, the system 120 may not invoke the skill to execute with respect to the user's natural language user inputs.

The profile storage 270 may include one or more group profiles. Each group profile may be associated with a different group identifier. A group profile may be specific to a group of users. That is, a group profile may be associated with two or more individual user profiles. For example, a group profile may be a household profile that is associated with user profiles associated with multiple users of a single household. A group profile may include preferences shared by all the user profiles associated therewith. Each user profile associated with a group profile may additionally include preferences specific to the user associated therewith. That is, each user profile may include preferences unique from one or more other user profiles associated with the same group profile. A user profile may be a stand-alone profile or may be associated with a group profile.

The profile storage 270 may include one or more device profiles. Each device profile may be associated with a different device identifier. Each device profile may include various device identifying information. Each device profile may also include one or more user identifiers, representing one or more users associated with the device. For example, a household device's profile may include the user identifiers of users of the household.

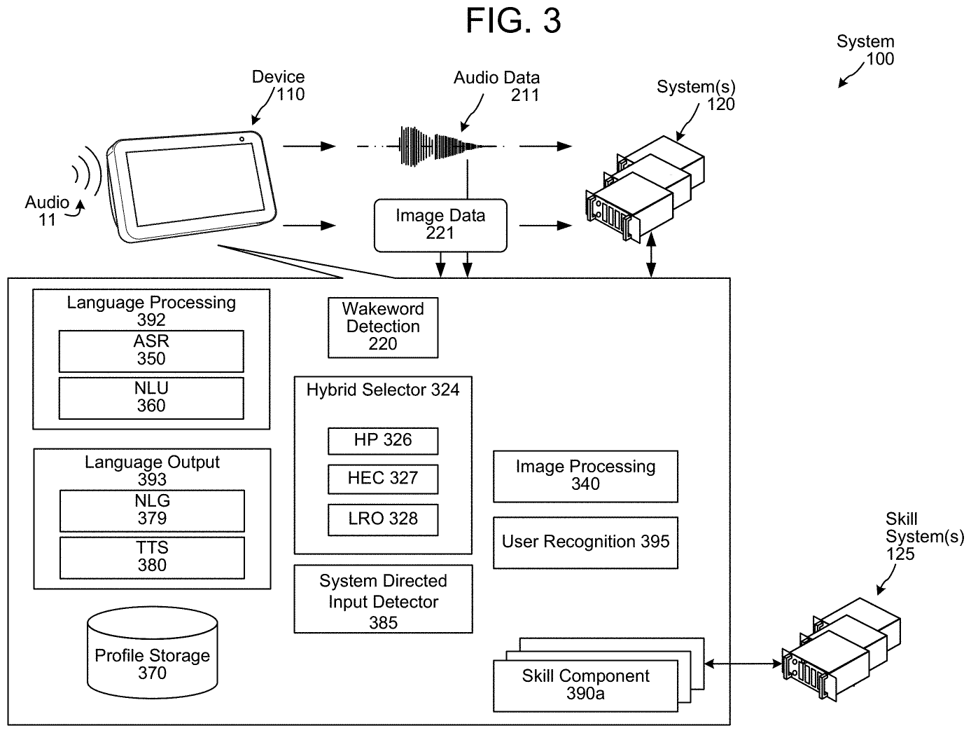

Although the components of FIG. 2 may be illustrated as part of system(s) 120, device 110, or otherwise, the components may be arranged in other device(s) (such as in device 110 if illustrated in system(s) 120 or vice-versa, or in other device(s) altogether) without departing from the disclosure. FIG. 3 illustrates such a configured device 110.

In at least some embodiments, the system 120 may receive the audio data 211 from the device 110, to recognize speech corresponding to a spoken input in the received audio data 211, and to perform functions in response to the recognized speech. In at least some embodiments, these functions involve sending directives (e.g., commands), from the system 120 to the device 110 (and/or other devices 110) to cause the device 110 to perform an action, such as output an audible response to the spoken input via a loudspeaker(s), and/or control secondary devices in the environment by sending a control command to the secondary devices.

Thus, when the device 110 is able to communicate with the system 120 over the network(s) 199, some or all of the functions capable of being performed by the system 120 may be performed by sending one or more directives over the network(s) 199 to the device 110, which, in turn, may process the directive(s) and perform one or more corresponding actions. For example, the system 120, using a remote directive that is included in response data (e.g., a remote response), may instruct the device 110 to output an audible response (e.g., using TTS processing performed by an on-device TTS component 380) to a user's question via a loudspeaker(s) of (or otherwise associated with) the device 110, to output content (e.g., music) via the loudspeaker(s) of (or otherwise associated with) the device 110, to display content on a display of (or otherwise associated with) the device 110, and/or to send a directive to a secondary device (e.g., a directive to turn on a smart light). It is to be appreciated that the system 120 may be configured to provide other functions in addition to those discussed herein, such as, without limitation, providing step-by-step directions for navigating from an origin location to a destination location, conducting an electronic commerce transaction on behalf of the user 5 as part of a shopping function, establishing a communication session (e.g., a video call) between the user 5 and another user, and so on.

As noted with respect to FIGS. 2 and 3, the device 110 may include a wakeword detection component 220 configured to compare the audio data 211 to stored models used to detect a wakeword (e.g., “Alexa”) that indicates to the device 110 that the audio data 211 is to be processed for determining NLU output data (e.g., slot data that corresponds to a named entity, label data, and/or intent data, etc.). In at least some embodiments, a hybrid selector 324, of the device 110, may send the audio data 211 to the wakeword detection component 220. If the wakeword detection component 220 detects a wakeword in the audio data 211, the wakeword detection component 220 may send an indication of such detection to the hybrid selector 324. In response to receiving the indication, the hybrid selector 324 may send the audio data 211 to the system 120 and/or the ASR component 350. The wakeword detection component 220 may also send an indication, to the hybrid selector 324, representing a wakeword was not detected. In response to receiving such an indication, the hybrid selector 324 may refrain from sending the audio data 211 to the system 120, and may prevent the ASR component 350 from further processing the audio data 211. In this situation, the audio data 211 can be discarded.

The device 110 may also include a system directed input detector 385. (The system 120 may also include a system directed input detector 285 which may operate in a manner similar to system directed input detector 385.) The system directed input detector 385 may be configured to determine whether an input to the system (for example speech, a gesture, etc.) is directed to the system or not directed to the system (for example directed to another user, etc.). The system directed input detector 385 may work in conjunction with the wakeword detector 220. If the system directed input detector 385 determines an input is directed to the system, the device 110 may “wake” and begin sending captured data for further processing (for example, processing audio data using the language processing 292/392, processing captured image data using image processing component 240/340 or the like). If data is being processed the device 110 may indicate such to the user, for example by activating or changing the color of an illuminated output (such as an LED ring), displaying an indicator on a display (such as a light bar across the display), outputting an audio indicator (such as a beep) or otherwise informing a user that input data is being processed. If the system directed input detector 385 determines an input is not directed to the system (such as a speech or gesture directed to another user) the device 110 may discard the data and take no further action for processing purposes. In this way the system 100 may prevent processing of data not directed to the system, thus protecting the users' privacy. As an indicator to the user, however, the system may output an audio, visual, or other indicator when the system directed input detector 385 is determining whether an input is potentially device directed. For example, the system may output an orange indicator while considering an input, and may output a green indicator if a system directed input is detected. Other such configurations are possible.

The device 110 may conduct its own speech processing using on-device language processing components, such as an SLU/language processing component 392 (which may include an ASR component 350 and an NLU 360), similar to the manner discussed herein with respect to the SLU component 292 (or ASR component 250 and the NLU component 260) of the system 120. Language processing component 392 may operate similarly to language processing component 292, ASR component 350 may operate similarly to ASR component 250 and NLU component 360 may operate similarly to NLU component 260. The device 110 may also internally include, or otherwise have access to, other components such as one or more skill components 390 capable of executing commands based on NLU output data or other results determined by the device 110/system 120 (which may operate similarly to skill components 290), a user recognition component 395 (configured to process in a similar manner to that discussed herein with respect to the user recognition component 295 of the system 120), profile storage 370 (configured to store similar profile data to that discussed herein with respect to the profile storage 270 of the system 120), or other components. In at least some embodiments, the profile storage 370 may only store profile data for a user or group of users specifically associated with the device 110. Similar to as described above with respect to skill component 290, a skill component 390 may communicate with a skill system(s) 125. The device 110 may also have its own language output component 393 which may include NLG component 379 and TTS component 380. Language output component 393 may operate similarly to language output component 293, NLG component 379 may operate similarly to NLG component 279 and TTS component 380 may operate similarly to TTS component 280.

In at least some embodiments, the on-device language processing components may not have the same capabilities as the language processing components of the system 120. For example, the on-device language processing components may be configured to handle only a subset of the natural language user inputs that may be handled by the system 120. For example, such subset of natural language user inputs may correspond to local-type natural language user inputs, such as those controlling devices or components associated with a user's home. In such circumstances the on-device language processing components may be able to more quickly interpret and respond to a local-type natural language user input, for example, than processing that involves the system 120. If the device 110 attempts to process a natural language user input for which the on-device language processing components are not necessarily best suited, the language processing results determined by the device 110 may indicate a low confidence or other metric indicating that the processing by the device 110 may not be as accurate as the processing done by the system 120.

The hybrid selector 324, of the device 110, may include a hybrid proxy (HP) 326 configured to proxy traffic to/from the system 120. For example, the HP 326 may be configured to send messages to/from a hybrid execution controller (HEC) 327 of the hybrid selector 324. For example, command/directive data received from the system 120 can be sent to the HEC 327 using the HP 326. The HP 326 may also be configured to allow the audio data 211 to pass to the system 120 while also receiving (e.g., intercepting) this audio data 211 and sending the audio data 211 to the HEC 327.

In at least some embodiments, the hybrid selector 324 may further include a local request orchestrator (LRO) 328 configured to notify the ASR component 350 about the availability of new audio data 211 that represents user speech, and to otherwise initiate the operations of local language processing when new audio data 211 becomes available. In general, the hybrid selector 324 may control execution of local language processing, such as by sending “execute” and “terminate” events/instructions. An “execute” event may instruct a component to continue any suspended execution (e.g., by instructing the component to execute on a previously-determined intent in order to determine a directive). Meanwhile, a “terminate” event may instruct a component to terminate further execution, such as when the device 110 receives directive data from the system 120 and chooses to use that remotely-determined directive data.

Thus, when the audio data 211 is received, the HP 326 may allow the audio data 211 to pass through to the system 120 and the HP 326 may also input the audio data 211 to the on-device ASR component 350 by routing the audio data 211 through the HEC 327 of the hybrid selector 324, whereby the LRO 328 notifies the ASR component 350 of the audio data 211. At this point, the hybrid selector 324 may wait for response data from either or both of the system 120 or the local language processing components. However, the disclosure is not limited thereto, and in some examples the hybrid selector 324 may send the audio data 211 only to the local ASR component 350 without departing from the disclosure. For example, the device 110 may process the audio data 211 locally without sending the audio data 211 to the system 120.

The local ASR component 350 is configured to receive the audio data 211 from the hybrid selector 324, and to recognize speech in the audio data 211, and the local NLU component 360 is configured to determine a user intent from the recognized speech, and to determine how to act on the user intent by generating NLU output data which may include directive data (e.g., instructing a component to perform an action). Such NLU output data may take a form similar to that as determined by the NLU component 260 of the system 120. In some cases, a directive may include a description of the intent (e.g., an intent to turn off {device A}). In some cases, a directive may include (e.g., encode) an identifier of a second device(s), such as kitchen lights, and an operation to be performed at the second device(s). Directive data may be formatted using Java, such as JavaScript syntax, or JavaScript-based syntax. This may include formatting the directive using JSON. In at least some embodiments, a device-determined directive may be serialized, much like how remotely-determined directives may be serialized for transmission in data packets over the network(s) 199. In at least some embodiments, a device-determined directive may be formatted as a programmatic application programming interface (API) call with a same logical operation as a remotely-determined directive. In other words, a device-determined directive may mimic a remotely-determined directive by using a same, or a similar, format as the remotely-determined directive.

An NLU hypothesis (output by the NLU component 360) may be selected as usable to respond to a natural language user input, and local response data may be sent (e.g., local NLU output data, local knowledge base information, internet search results, and/or local directive data) to the hybrid selector 324, such as a “ReadyToExecute” response. The hybrid selector 324 may then determine whether to use directive data from the on-device components to respond to the natural language user input, to use directive data received from the system 120, assuming a remote response is even received (e.g., when the device 110 is able to access the system 120 over the network(s) 199), or to determine output audio requesting additional information from the user 5.

The device 110 and/or the system 120 may associate a unique identifier with each natural language user input. The device 110 may include the unique identifier when sending the audio data 211 to the system 120, and the response data from the system 120 may include the unique identifier to identify which natural language user input the response data corresponds.

In at least some embodiments, the device 110 may include, or be configured to use, one or more skill components 390 that may work similarly to the skill component(s) 290 implemented by the system 120. The skill component(s) 390 may correspond to one or more domains that are used in order to determine how to act on a spoken input in a particular way, such as by outputting a directive that corresponds to the determined intent, and which can be processed to implement the desired operation. The skill component(s) 390 installed on the device 110 may include, without limitation, a smart home skill component (or smart home domain) and/or a device control skill component (or device control domain) to execute in response to spoken inputs corresponding to an intent to control a second device(s) in an environment, a music skill component (or music domain) to execute in response to spoken inputs corresponding to a intent to play music, a navigation skill component (or a navigation domain) to execute in response to spoken input corresponding to an intent to get directions, a shopping skill component (or shopping domain) to execute in response to spoken inputs corresponding to an intent to buy an item from an electronic marketplace, and/or the like.

Additionally or alternatively, the device 110 may be in communication with one or more skill systems 125. For example, a skill system 125 may be located in a remote environment (e.g., separate location) such that the device 110 may only communicate with the skill system 125 via the network(s) 199. However, the disclosure is not limited thereto. For example, in at least some embodiments, a skill system 125 may be configured in a local environment (e.g., home server and/or the like) such that the device 110 may communicate with the skill system 125 via a private network, such as a local area network (LAN).

As used herein, a “skill” may refer to a skill component 390, a skill system 125, or a combination of a skill component 390 and a corresponding skill system 125. Similar to the manner discussed with regard to FIG. 2, the local device 110 may be configured to recognize multiple different wakewords and/or perform different categories of tasks depending on the wakeword. Such different wakewords may invoke different processing components of local device 110 (not illustrated in FIG. 3). For example, detection of the wakeword “Alexa” by the wakeword detector 220 may result in sending audio data to certain language processing components 392/skills 390 for processing while detection of the wakeword “Computer” by the wakeword detector may result in sending audio data different language processing components 392/skills 390 for processing.

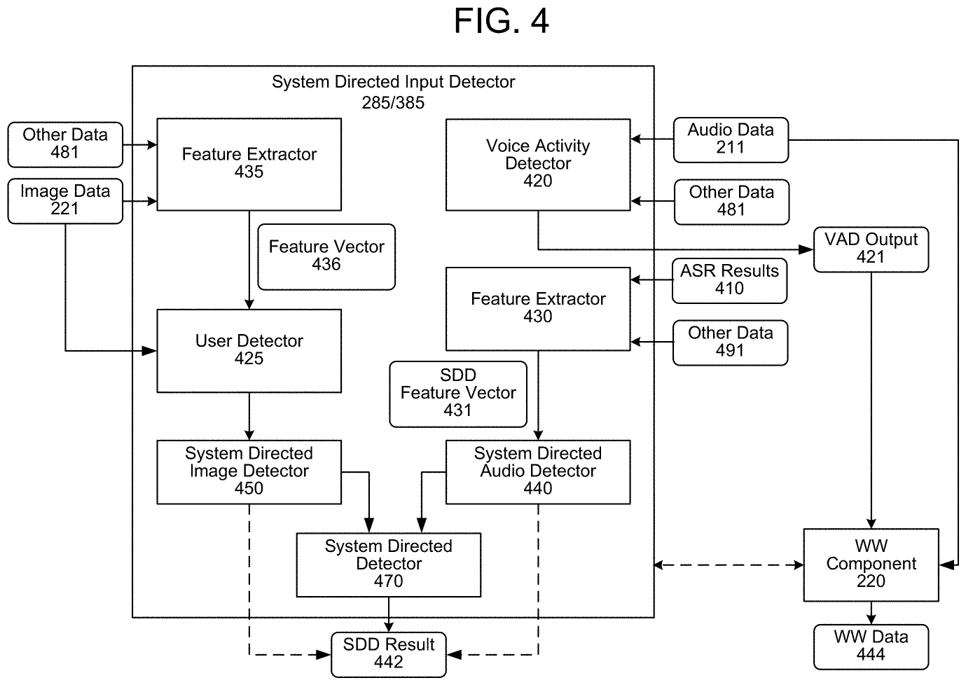

Configuration and operation of the system directed input detector 285/385 is illustrated in FIG. 4. As shown in FIG. 4, the system directed input detector 285/385 may include a number of different components. First, the system directed input detector 285/385 may include a voice activity detector (VAD) 420. The VAD 420 may operate to detect whether the incoming audio data 211 includes speech or not. The VAD output 421 may be a binary indicator. Thus, if the incoming audio data 211 includes speech, the VAD 420 may output an indicator 421 that the audio data 211 does includes speech (e.g., a 1) and if the incoming audio data 211 does not includes speech, the VAD 420 may output an indicator 421 that the audio data 211 does not includes speech (e.g., a 0). The VAD output 421 may also be a score (e.g., a number between 0 and 1) corresponding to a likelihood that the audio data 211 includes speech. The VAD 420 may also perform start-point detection as well as end-point detection where the VAD 420 determines when speech starts in the audio data 211 and when it ends in the audio data 211. Thus the VAD output 421 may also include indicators of a speech start point and/or a speech endpoint for use by other components of the system. (For example, the start-point and end-points may demarcate the audio data 211 that is sent to the speech processing component 240.) The VAD output 421 may be associated with a same unique ID as the audio data 211 for purposes of tracking system processing across various components.

The VAD 420 may operate using a variety of VAD techniques, including those described above with regard to VAD operations performed by device 110. The VAD may be configured to be robust to background noise so as to accurately detect when audio data actually includes speech or not. The VAD 420 may operate on raw audio data 211 such as that sent by device 110 or may operate on feature vectors or other data representing the audio data 211. For example, the VAD 420 may take the form of a deep neural network (DNN) and may operate on a single feature vector representing the entirety of audio data 211 received from the device or may operate on multiple feature vectors, for example feature vectors representing frames of audio data where each frame covers a certain amount of time of audio data (e.g., 25 ms). The VAD 420 may also operate on other data 481 that may be useful in detecting voice activity in the audio data 211. For example, the other data 481 may include results of anchored speech detection where the system takes a representation (such as a voice fingerprint, reference feature vector, etc.) of a reference section of speech (such as speech of a voice that uttered a previous command to the system that included a wakeword) and compares a voice detected in the audio data 211 to determine if that voice matches a voice in the reference section of speech. If the voices match, that may be an indicator to the VAD 420 that speech was detected. If not, that may be an indicator to the VAD 420 that speech was not detected. (For example, a representation may be taken of voice data in the first input audio data which may then be compared to the second input audio data to see if the voices match. If they do (or do not) that information may be considered by the VAD 420.) The VAD 420 may also consider other data when determining if speech was detected. The VAD 420 may also consider speaker ID information (such as may be output by user recognition component 295), directionality data that may indicate what direction (relative to the capture device 110) the incoming audio was received from. Such directionality data may be received from the device 110 and may have been determined by a beamformer or other component of device 110. The VAD 420 may also consider data regarding a previous utterance which may indicate whether the further audio data received by the system is likely to include speech. Other VAD techniques may also be used.

If the VAD output 421 indicates that no speech was detected the system (through orchestrator 230 or some other component) may discontinue processing with regard to the audio data 211, thus saving computing resources that might otherwise have been spent on other processes (e.g., ASR for the audio data 211, etc.). If the VAD output 421 indicates that speech was detected, the system may make a determination as to whether the speech was or was not directed to the speech-processing system. Such a determination may be made by the system directed audio detector 440. The system directed audio detector 440 may include a trained model, such as a DNN, that operates on a feature vector which represent certain data that may be useful in determining whether or not speech is directed to the system. To create the feature vector operable by the system directed audio detector 440, a feature extractor 430 may be used. The feature extractor 430 may input ASR results 410 which include results from the processing of the audio data 211 by a speech recognition component.

For privacy protection purposes, in certain configurations the ASR results 410 may be obtained from a language processing component 392/ASR component 350 located on device 110 or on a home remote component as opposed to a language processing component 292/ASR component 250 located on a cloud or other remote system 120 so that audio data 211 is not sent remote from the user's home unless the system directed input detector component 385 has determined that the input is system directed. Though this may be adjusted depending on user preferences/system configuration.

The ASR results 410 may include an N-best list of top scoring ASR hypotheses and their corresponding scores, portions (or all of) an ASR lattice/trellis with scores, portions (or all of) an ASR search graph with scores, portions (or all of) an ASR confusion network with scores, or other such ASR output. As an example, the ASR results 410 may include a trellis, which may include a raw search graph as scored during ASR decoding. The ASR results 410 may also include a lattice, which may be a trellis as scored that has been pruned to remove certain hypotheses that do not exceed a score threshold or number of hypotheses threshold. The ASR results 410 may also include a confusion network where paths from the lattice have been merged (e.g., merging hypotheses that may share all or a portion of a same word). The confusion network may be a data structure corresponding to a linear graph that may be used as an alternate representation of the most likely hypotheses of the decoder lattice. The ASR results 410 may also include corresponding respective scores (such as for a trellis, lattice, confusion network, individual hypothesis, N-best list, etc.)

The ASR results 410 (or other data 491) may include other ASR result related data such as other features from the ASR system or data determined by another component. For example, the system may determine an entropy of the ASR results (for example a trellis entropy or the like) that indicates a how spread apart the probability mass of the trellis is among the alternate hypotheses. A large entropy (e.g., large spread of probability mass over many hypotheses) may indicate the ASR component 250 being less confident about its best hypothesis, which in turn may correlate to detected speech not being device directed. The entropy may be a feature included in other data 491 to be considered by the system directed audio detector 440.

The system may also determine and consider ASR decoding costs, which may include features from Viterbi decoding costs of the ASR. Such features may indicate how well the input acoustics and vocabulary match with the acoustic models and language models. Higher Viterbi costs may indicate greater mismatch between the model and the given data, which may correlate to detected speech not being device directed. Confusion network feature may also be used. For example, an average number of arcs (where each arc represents a word) from a particular node (representing a potential join between two words) may measure how many competing hypotheses there are in the confusion network. A large number of competing hypotheses may indicate that the ASR component 250 is less confident about the top hypothesis, which may correlate to detected speech not being device directed. Other such features or data from the ASR results 410 may also be used as other data 491.

The ASR results 410 may be represented in a system directed detector (SDD) feature vector 431 that can be used to determine whether speech was system-directed. The feature vector 431 may represent the ASR results 410 but may also represent audio data 211 (which may be input to feature extractor 430) or other information. Such ASR results may be helpful in determining if speech was system-directed. For example, if ASR results include a high scoring single hypothesis, that may indicate that the speech represented in the audio data 211 is directed at, and intended for, the device 110. If, however, ASR results do not include a single high scoring hypothesis, but rather many lower scoring hypotheses, that may indicate some confusion on the part of the speech recognition component 250 and may also indicate that the speech represented in the audio data 211 was not directed at, nor intended for, the device 110.

The ASR results 410 may include complete ASR results, for example ASR results corresponding to all speech between a startpoint and endpoint (such as a complete lattice, etc.). In this configuration the system may wait until all ASR processing for a certain input audio has been completed before operating the feature extractor 430 and system directed audio detector 440. Thus the system directed audio detector 440 may receive a feature vector 431 that includes all the representations of the audio data 211 created by the feature extractor 430. The system directed audio detector 440 may then operate a trained model (such as a DNN) on the feature vector 431 to determine a score corresponding to a likelihood that the audio data 211 includes a representation of system-directed speech. If the score is above a threshold, the system directed audio detector 440 may determine that the audio data 211 does include a representation of system-directed speech. The SDD result 442 may include an indicator of whether the audio data includes system-directed speech, a score, and/or some other data.

The ASR results 410 may also include incomplete ASR results, for example ASR results corresponding to only some speech between a between a startpoint and endpoint (such as an incomplete lattice, etc.). In this configuration the feature extractor 430/system directed audio detector 440 may be configured to operate on incomplete ASR results 410 and thus the system directed audio detector 440 may be configured to output an SSD result 442 that provides an indication as to whether the portion of audio data processed (that corresponds to the incomplete ASR results) corresponds to system directed speech. The system may thus be configured to perform ASR at least partially in parallel with the system directed audio detector 440 to process ASR result data as it is ready and thus continually update an SDD result 442. Once the system directed input detector 285/385 has processed enough ASR results and/or the SDD result 442 exceeds a threshold, the system may determine that the audio data 211 includes system-directed speech. Similarly, once the system directed input detector 285/385 has processed enough ASR results and/or the SDD result 442 drops below another threshold, the system may determine that the audio data 211 does not include system-directed speech.

The SDD result 442 may be associated with a same unique ID as the audio data 211 and VAD output 421 for purposes of tracking system processing across various components.

The feature extractor 430 may also incorporate in a feature vector 431 representations of other data 491. Other data 491 may include, for example, word embeddings from words output by the speech recognition component may be considered. Word embeddings are vector representations of words or sequences of words that show how specific words may be used relative to other words, such as in a large text corpus. A word embedding may be of a different length depending on how many words are in a text segment represented by the word embedding. For purposes of the feature extractor 430 processing and representing a word embedding in a feature vector 431 (which may be of a fixed length), a word embedding of unknown length may be processed by a neural network with memory, such as an LSTM (long short term memory) network. Each vector of a word embedding may be processed by the LSTM which may then output a fixed representation of the input word embedding vectors.

Other data 491 may also include, for example, NLU output from the natural language 260 component may be considered. Thus, if natural language output data 1585/1525 indicates a high correlation between the audio data 211 and an out-of-domain indication (e.g., no intent classifier scores from ICs or overall domain scores from recognizers reach a certain confidence threshold), this may indicate that the audio data 211 does not include system-directed speech. Other data 491 may also include, for example, an indicator of a user/speaker as output user recognition component 295. Thus, for example, if the user recognition component 295 does not indicate the presence of a known user, or indicates the presence of a user associated with audio data 211 that was not associated with a previous utterance, this may indicate that the audio data 211 does not include system-directed speech. The other data 491 may also include an indication that a voice represented in audio data 211 is the same (or different) as the voice detected in previous input audio data corresponding to a previous utterance. The other data 491 may also include directionality data, for example using beamforming or other audio processing techniques to determine a direction/location of a source of detected speech and whether that source direction/location matches a speaking user. The other data 491 may also include data indicating that a direction of a user's speech is toward a device 110 or away from a device 110, which may indicate whether the speech was system directed or not.

Other data 491 may also include image data 112. For example, if image data is detected from one or more devices that are nearby to the device 110 (which may include the device 110 itself) that captured the audio data being processed using the system directed input detector (285/385), the image data may be processed to determine whether a user is facing an audio capture device for purposes of determining whether speech is system-directed as further explained below.

Other data 491 may also dialog history data. For example, the other data 491 may include information about whether a speaker has changed from a previous utterance to the current audio data 211, whether a topic of conversation has changed from a previous utterance to the current audio data, how NLU results from a previous utterance compare to NLU results obtained using the current audio data 211, other system context information. The other data 491 may also include an indicator as to whether the audio data 211 was received as a result of a wake command or whether the audio data 211 was sent without the device 110 detecting a wake command (e.g., the device 110 being instructed by remote system 120 and/or determining to send the audio data without first detecting a wake command).

Other data 491 may also include information from the user profile 270.

Other data 491 may also include direction data, for example data regarding a direction of arrival of speech detected by the device, for example a beam index number, angle data, or the like. If second audio data is received from a different direction than first audio data, then the system may be less likely to declare the second audio data to include system-directed speech since it is originating from a different location.

Other data 491 may also include acoustic feature data such as pitch, prosody, intonation, volume, or other data descriptive of the speech in the audio data 211. As a user may use a different vocal tone to speak with a machine than with another human, acoustic feature information may be useful in determining if speech is device-directed.

Other data 491 may also include an indicator that indicates whether the audio data 211 includes a wakeword. For example, if a device 110 detects a wakeword prior to sending the audio data 211 to the remote system 120, the device 110 may send along an indicator that the device 110 detected a wakeword in the audio data 211. In another example, the remote system 120 may include another component that processes incoming audio data 211 to determine if it includes a wakeword. If it does, the component may create an indicator indicating that the audio data 211 includes a wakeword. The indicator may then be included in other data 491 to be incorporated in the feature vector 431 and/or otherwise considered by the system directed audio detector 440.

Other data 491 may also include device history data such as information about previous operations related to the device 110 that sent the audio data 211. For example, the other data 491 may include information about a previous utterance that was just executed, where the utterance originated with the same device 110 as a current utterance and the previous utterance was within a certain time window of the current utterance. Device history data may be stored in a manner associated with the device identifier (which may also be included in other data 491), which may also be used to track other information about the device, such as device hardware, capability, location, etc.

The other data 481 used by the VAD 420 may include similar data and/or different data from the other data 491 used by the feature extractor 430. The other data 481/491 may thus include a variety of data corresponding to input audio from a previous utterance. That data may include acoustic data from a previous utterance, speaker ID/voice identification data from a previous utterance, information about the time between a previous utterance and a current utterance, or a variety of other data described herein taken from a previous utterance. A score threshold (for the system directed audio detector 440 and/or the VAD 420) may be based on the data from the previous utterance. For example, a score threshold (for the system directed audio detector 440 and/or the VAD 420) may be based on acoustic data from a previous utterance.

The feature extractor 430 may output a single feature vector 431 for one utterance/instance of input audio data 411. The feature vector 431 may consistently be a fixed length, or may be a variable length vector depending on the relevant data available for particular audio data 211. Thus, the system directed audio detector 440 may output a single SDD result 442 per utterance/instance of input audio data 411. The SDD result 442 may be a binary indicator. Thus, if the incoming audio data 211 includes system-directed speech, the system directed audio detector 440 may output an indicator 442 that the audio data 211 does includes system-directed speech (e.g., a 1) and if the incoming audio data 211 does not includes system-directed speech, the system directed audio detector 440 may output an indicator 442 that the audio data 211 does not system-directed includes speech (e.g., a 0). The SDD result 442 may also be a score (e.g., a number between 0 and 1) corresponding to a likelihood that the audio data 211 includes system-directed speech. Although not illustrated in FIG. 4, the flow of data to and from the system directed input detector 285/385 may be managed by the orchestrator 230 or by one or more other components.

The trained model(s) of the system directed audio detector 440 may be trained on many different examples of SDD feature vectors that include both positive and negative training samples (e.g., samples that both represent system-directed speech and non-system directed speech) so that the DNN and/or other trained model of the system directed audio detector 440 may be capable of robustly detecting when speech is system-directed versus when speech is not system-directed.

A further input to the system directed input detector 285/385 may include output data from TTS component 280 to avoid synthesized speech output by the system being confused as system-directed speech spoken by a user. The output from the TTS component 280 may allow the system to ignore synthesized speech in its considerations of whether speech was system directed. The output from the TTS component 280 may also allow the system to determine whether a user captured utterance is responsive to the TTS output, thus improving system operation.

The system directed input detector 285/385 may also use echo return loss enhancement (ERLE) and/or acoustic echo cancellation (AEC) data to avoid processing of audio data generated by the system.

As shown in FIG. 4, the system directed input detector 285/385 may simply user audio data to determine whether an input is system directed (for example, system directed audio detector 440 may output an SDD result 442). This may be true particularly when no image data is available (for example for a device without a camera). If image data 112 is available, however, the system may also be configured to use image data 112 to determine if an input is system directed. The image data 112 may include image data captured by device 110 and/or image data captured by other device(s) in the environment of device 110. The audio data 211, image data 112 and other data 481 may be timestamped or otherwise correlated so that the system directed input detector 285/385 may determine that the data being analyzed all relates to a same time window so as to ensure alignment of data considered with regard to whether a particular input is system directed. For example, the system directed input detector 285/385 may determine system directedness scores for every frame of audio data/every image of a video stream and may align and/or window them to determine a single overall score for a particular input that corresponds to a group of audio frames/images.

Image data 112 along with other data 481 may be received by feature extractor 435. The feature extractor may create one or more feature vectors 436 which may represent the image data 112/other data 481. In certain examples, other data 481 may include data from image processing component 240 which may include information about faces, gesture, etc. detected in the image data 112. For privacy protection purposes, in certain configurations any image processing/results thereof may be obtained from an image processing component 340 located on device 110 or on a home remote component as opposed to a image processing component 240 located on a cloud or other remote system 120 so that image data 112 is not sent remote from the user's home unless the system directed input detector component 385 has determined that the input is system directed. Though this may be adjusted depending on user preferences/system configuration.

The feature vector 436 may be passed to the user detector 425. The user detector 425 (which may use various components/operations of image processing component 240, user recognition component 295, etc.) may be configured to process image data 112 and/or feature vector 436 to determine information about the user's behavior which in turn may be used to determine if an input is system directed. For example, the user detector 425 may be configured to determine the user's position/behavior with respect to device 110/system 100. The user detector 425 may also be configured to determine whether a user's mouth is opening/closing in a manner that suggests the user is speaking. The user detector 425 may also be configured to determine whether a user is nodding or shaking his/her head. The user detector 425 may also be configured to determine whether a user's gaze is directed to the device 110, to another user, or to another object. For example, the use detector 425 may include, or be configured to use data from, a gaze detector 565. The user detector 425 may also be configured to determine gestures of the user such as a shoulder shrug, pointing toward an object, a wave, a hand up to indicate an instruction to stop, or a fingers moving to indicate an instruction to continue, holding up a certain number of fingers, putting a thumb up, etc. The user detector 425 may also be configured to determine a user's position/orientation such as facing another user, facing the device 110, whether their back is turned, etc. The user detector 425 may also be configured to determine relative positions of multiple users that appear in image data (and/or are speaking in audio data 211 which may also be considered by the user detector 425 along with feature vector 431), for example which users are closer to a device 110 and which are farther away. The user detector 425 (and/or other component) may also be configured to identify other objects represented in image data and determine whether objects are relevant to a dialog or system interaction (for example determining if a user is referring to an object through a movement or speech).

The user detector 425 may operate one or more models (e.g., one or more classifiers) to determine if certain situations are represented in the image data 112. For example the user detector 425 may employ a visual directedness classifier that may determine, for each face detected in the image data 112 whether that face is looking at the device 110 or not. For example, a light-weight convolutional neural network (CNN) may be used which takes a face image cropped from the result of the face detector as input and output a [0,1] score of how likely the face is directed to the camera or not. Another technique may include to determine a three-dimensional (3D) landmark of each face, estimate the 3D angle of the face and predict a directness score based on the 3D angle.

The user detector 425 (or other component(s) such as those in image processing 240) may be configured to track a face in image data to determine which faces represented may belong to a same person. The system may user IOU based tracker, a mean-shift based tracker, a particle filter based tracker or other technique.

The user detector 425 (or other component(s) such as those in user recognition component 295) may be configured to determine whether a face represented in image data belongs to a person who is speaking or not, thus performing active speaker detection. The system may take the output from the face tracker and aggregate a sequence of face from the same person as input and predict whether this person is speaking or not. Lip motion, user ID, detected voice data, and other data may be used to determine whether a user is speaking or not.

The system directed image detector 450 may then determine, based on information from the user detector 425 as based on the image data whether an input relating to the image data is system directed. The system directed image detector 450 may also operate on other input data, for example image data including raw image data 112, image data including feature data 436 based on raw image data, other data 481, or other data. The determination by the system directed image detector 450 may result in a score indicating whether the input is system directed based on the image data. If no audio data is available, the indication may be output as SDD result 442. If audio data is available, the indication may be sent to system directed detector 470 which may consider information from both system directed audio detector 440 and system directed image detector 450. The system directed detector 470 may then process the data from both system directed audio detector 440 and system directed image detector 450 to come up with an overall determination as to whether an input was system directed, which may be output as SDD result 442. The system directed detector 470 may consider not only data output from system directed audio detector 440 and system directed image detector 450 but also other data/metadata corresponding to the input (for example, image data/feature data 436, audio data/feature data 431, image data 112, audio data 211, or the like discussed with regard to FIG. 4. The system directed detector 470 may include one or more models which may analyze the various input data to make a determination regarding SDD result 442.

In one example the determination of the system directed detector 470 may be based on “AND” logic, for example determining an input is system directed only if affirmative data is received from both system directed audio detector 440 and system directed image detector 450. In another example the determination of the system directed detector 470 may be based on “OR” logic, for example determining an input is system directed if affirmative data is received from either system directed audio detector 440 or system directed image detector 450. In another example the data received from system directed audio detector 440 and system directed image detector 450 are weighted individually based on other information available to system directed detector 470 to determine to what extend audio and/or image data should impact the decision of whether an input is system directed.

The system directed input detector 285/385 may also receive information from a wakeword component 220. For example, an indication that a wakeword was detected (e.g., WW data 444) may be considered by the system directed input detector 285/385 (e.g., by system directed audio detector 440, system directed detector 470, etc.) as part of the overall consideration of whether a system input was device directed. Detection of a wakeword may be considered a strong signal that a particular input was device directed.

If an input is determined to be system directed, the data related to the input may be sent to downstream components for further processing (e.g., to language processing 292). If an input is determined not to be system directed, the system may take no further action regarding the data related to the input and may allow it to be deleted. In certain configurations, to maintain privacy, the operations to determine whether an input is system directed are performed by device 110 (or home server(s) 120) and only if the input is determined to be system directed is further data (such as audio data 211 or image data 112) sent to a remote system 120 that is outside a user's home or other direct control.

As shown in FIG. 5, the system(s) 120 may include image processing component 240. The image processing component 240 may located across different physical and/or virtual machines. The image processing component 240 may receive and analyze image data (which may include single images or a plurality of images such as in a video feed). The image processing component 240 may work with other components of the system 120 to perform various operations. For example the image processing component 240 may work with user recognition component 295 to assist with user recognition using image data. The image processing component 240 may also include or otherwise be associated with image data storage 570 which may store aspects of image data used by image processing component 240. The image data may be of different formats such as JPEG, GIF, BMP, MPEG, video formats, and the like.

Image matching algorithms, such as those used by image processing component 240, may take advantage of the fact that an image of an object or scene contains a number of feature points. Feature points are specific points in an image which are robust to changes in image rotation, scale, viewpoint or lighting conditions. This means that these feature points will often be present in both the images to be compared, even if the two images differ. These feature points may also be known as “points of interest.” Therefore, a first stage of the image matching algorithm may include finding these feature points in the image. An image pyramid may be constructed to determine the feature points of an image. An image pyramid is a scale-space representation of the image, e.g., it contains various pyramid images, each of which is a representation of the image at a particular scale. The scale-space representation enables the image matching algorithm to match images that differ in overall scale (such as images taken at different distances from an object). Pyramid images may be smoothed and downsampled versions of an original image.

To build a database of object images, with multiple objects per image, a number of different images of an object may be taken from different viewpoints. From those images, feature points may be extracted and pyramid images constructed. Multiple images from different points of view of each particular object may be taken and linked within the database (for example within a tree structure described below). The multiple images may correspond to different viewpoints of the object sufficient to identify the object from any later angle that may be included in a user's query image. For example, a shoe may look very different from a bottom view than from a top view than from a side view. For certain objects, this number of different image angles may be 6 (top, bottom, left side, right side, front, back), for other objects this may be more or less depending on various factors, including how many images should be taken to ensure the object may be recognized in an incoming query image. With different images of the object available, it is more likely that an incoming image from a user may be recognized by the system and the object identified, even if the user's incoming image is taken at a slightly different angle.

This process may be repeated for multiple objects. For large databases, such as an online shopping database where a user may submit an image of an object to be identified, this process may be repeated thousands, if not millions of times to construct a database of images and data for image matching. The database also may continually be updated and/or refined to account for a changing catalog of objects to be recognized.

When configuring the database, pyramid images, feature point data, and/or other information from the images or objects may be used to cluster features and build a tree of objects and images, where each node of the tree will keep lists of objects and corresponding features. The tree may be configured to group visually significant subsets of images/features to ease matching of submitted images for object detection. Data about objects to be recognized may be stored by the system in image data 570, profile storage 270, or other storage component.

Image selection component 520 may select desired images from input image data to use for image processing at runtime. For example, input image data may come from a series of sequential images, such as a video stream where each image is a frame of the video stream. These incoming images need to be sorted to determine which images will be selected for further object recognition processing as performing image processing on low quality images may result in an undesired user experience. To avoid such an undesirable user experience, the time to perform the complete recognition process, from first starting the video feed to delivering results to the user, should be as short as possible. As images in a video feed may come in rapid succession, the image processing component 240 may be configured to select or discard an image quickly so that the system can, in turn, quickly process the selected image and deliver results to a user. The image selection component 520 may select an image for object recognition by computing a metric/feature for each frame in the video feed and selecting an image for processing if the metric exceeds a certain threshold. While FIG. 5 illustrates image selection component 520 as part of system 120, it may also be located on device 110 so that the device may select only desired image(s) to send to system 120, thus avoiding sending too much image data to system 120 (thus expending unnecessary computing/communication resources). Thus the device may select only the best quality images for purposes of image analysis.

The metrics used to select an image may be general image quality metrics (focus, sharpness, motion, etc.) or may be customized image quality metrics. The metrics may be computed by software components or hardware components. For example, the metrics may be derived from output of device sensors such as a gyroscope, accelerometer, field sensors, inertial sensors, camera metadata, or other components. The metrics may thus be image based (such as a statistic derived from an image or taken from camera metadata like focal length or the like) or may be non-image based (for example, motion data derived from a gyroscope, accelerometer, GPS sensor, etc.). As images from the video feed are obtained by the system, the system, such as a device, may determine metric values for the image. One or more metrics may be determined for each image. To account for temporal fluctuation, the individual metrics for each respective image may be compared to the metric values for previous images in the image feed and thus a historical metric value for the image and the metric may be calculated. This historical metric may also be referred to as a historical metric value. The historical metric values may include representations of certain metric values for the image compared to the values for that metric for a group of different images in the same video feed. The historical metric(s) may be processed using a trained classifier model to select which images are suitable for later processing.

For example, if a particular image is to be measured using a focus metric, which is a numerical representation of the focus of the image, the focus metric may also be computed for the previous N frames to the particular image. N is a configurable number and may vary depending on system constraints such as latency, accuracy, etc. For example, N may be 30 image frames, representing, for example, one second of video at a video feed of 30 frames-per-second. A mean of the focus metrics for the previous N images may be computed, along with a standard deviation for the focus metric. For example, for an image number X+1 in a video feed sequence, the previous N images, may have various metric values associated with each of them. Various metrics such as focus, motion, and contrast are discussed, but others are possible. A value for each metric for each of the N images may be calculated, and then from those individual values, a mean value and standard deviation value may be calculated. The mean and standard deviation (STD) may then be used to calculate a normalized historical metric value, for example STD(metric)/MEAN(metric). Thus, the value of a historical focus metric at a particular image may be the STD divided by the mean for the focus metric for the previous N frames. For example, historical metrics (HIST) for focus, motion, and contrast may be expressed as:

$${HIST}_{F o c u s} = \frac{S T {D}_{F o c u s}}{{MEAN}_{F o c u s}}$$

$${HIST}_{Motion} = \frac{S T {D}_{M o t i o n}}{{MEAN}_{M o t i o n}}$$

$${HIST}_{Contrast} = \frac{S T {D}_{C o n t r a s t}}{{MEAN}_{C o n t r a s t}}$$

In one embodiment the historical metric may be further normalized by dividing the above historical metrics by the number of frames N, particularly in situations where there are small number of frames under consideration for the particular time window. The historical metrics may be recalculated with each new image frame that is received as part of the video feed. Thus each frame of an incoming video feed may have a different historical metric from the frame before. The metrics for a particular image of a video feed may be compared historical metrics to select a desirable image on which to perform image processing.

Image selection component 520 may perform various operations to identify potential locations in an image that may contain recognizable text. This process may be referred to as glyph region detection. A glyph is a text character that has yet to be recognized. If a glyph region is detected, various metrics may be calculated to assist the eventual optical character recognition (OCR) process. For example, the same metrics used for overall image selection may be re-used or recalculated for the specific glyph region. Thus, while the entire image may be of sufficiently high quality, the quality of the specific glyph region (i.e. focus, contrast, intensity, etc.) may be measured. If the glyph region is of poor quality, the image may be rejected for purposes of text recognition.

Image selection component 520 may generate a bounding box that bounds a line of text. The bounding box may bound the glyph region. Value(s) for image/region suitability metric(s) may be calculated for the portion of the image in the bounding box. Value(s) for the same metric(s) may also be calculated for the portion of the image outside the bounding box. The value(s) for inside the bounding box may then be compared to the value(s) outside the bounding box to make another determination on the suitability of the image. This determination may also use a classifier.

Additional features may be calculated for determining whether an image includes a text region of sufficient quality for further processing. The values of these features may also be processed using a classifier to determine whether the image contains true text character/glyphs or is otherwise suitable for recognition processing. To locally classify each candidate character location as a true text character/glyph location, a set of features that capture salient characteristics of the candidate location is extracted from the local pixel pattern. Such features may include aspect ratio (bounding box width/bounding box height), compactness (4*π*candidate glyph area/(perimeter)), solidity (candidate glyph area/bounding box area), stroke-width to width ratio (maximum stroke width/bounding box width), stroke-width to height ratio (maximum stroke width/bounding box height), convexity (convex hull perimeter/perimeter), raw compactness (4*π*(candidate glyph number of pixels)/(perimeter)), number of holes in candidate glyph, or other features. Other candidate region identification techniques may be used. For example, the system may use techniques involving maximally stable extremal regions (MSERs). Instead of MSERs (or in conjunction with MSERs), the candidate locations may be identified using histogram of oriented gradients (HoG) and Gabor features.

If an image is sufficiently high quality it may be selected by image selection 520 for sending to another component (e.g., from device to system 120) and/or for further processing, such as text recognition, object detection/resolution, etc.

The feature data calculated by image selection component 520 may be sent to other components such as text recognition component 540, objection detection component 530, object resolution component 550, etc. so that those components may use the feature data in their operations. Other preprocessing operations such as masking, binarization, etc. may be performed on image data prior to recognition/resolution operations. Those preprocessing operations may be performed by the device prior to sending image data or by system 120.

Object detection component 530 may be configured to analyze image data to identify one or more objects represented in the image data. Various approaches can be used to attempt to recognize and identify objects, as well as to determine the types of those objects and applications or actions that correspond to those types of objects, as is known or used in the art. For example, various computer vision algorithms can be used to attempt to locate, recognize, and/or identify various types of objects in an image or video sequence. Computer vision algorithms can utilize various different approaches, as may include edge matching, edge detection, recognition by parts, gradient matching, histogram comparisons, interpretation trees, and the like.

The object detection component 530 may process at least a portion of the image data to determine feature data. The feature data is indicative of one or more features that are depicted in the image data. For example, the features may be face data, or other objects, for example as represented by stored data in profile storage 270. Other examples of features may include shapes of body parts or other such features that identify the presence of a human. Other examples of features may include edges of doors, shadows on the wall, texture on the walls, portions of artwork in the environment, and so forth to identify a space. The object detection component 530 may compare detected features to stored data (e.g., in profile storage 270, image data 570, or other storage) indicating how detected features may relate to known objects for purposes of object detection.

Various techniques may be used to determine the presence of features in image data. For example, one or more of a Canny detector, Sobel detector, difference of Gaussians, features from accelerated segment test (FAST) detector, scale-invariant feature transform (SIFT), speeded up robust features (SURF), color SIFT, local binary patterns (LBP), trained convolutional neural network, or other detection methodologies may be used to determine features in the image data. A feature that has been detected may have an associated descriptor that characterizes that feature. The descriptor may comprise a vector value in some implementations. For example, the descriptor may comprise data indicative of the feature with respect to many (e.g., 256) different dimensions.

One statistical algorithm that may be used for geometric matching of images is the Random Sample Consensus (RANSAC) algorithm, although other variants of RANSAC-like algorithms or other statistical algorithms may also be used. In RANSAC, a small set of putative correspondences is randomly sampled. Thereafter, a geometric transformation is generated using these sampled feature points. After generating the transformation, the putative correspondences that fit the model are determined. The putative correspondences that fit the model and are geometrically consistent and called “inliers.” The inliers are pairs of feature points, one from each image, that may correspond to each other, where the pair fits the model within a certain comparison threshold for the visual (and other) contents of the feature points, and are geometrically consistent (as explained below relative to motion estimation). A total number of inliers may be determined. The above mentioned steps may be repeated until the number of repetitions/trials is greater than a predefined threshold or the number of inliers for the image is sufficiently high to determine an image as a match (for example the number of inliers exceeds a threshold). The RANSAC algorithm returns the model with the highest number of inliers corresponding to the model.

To further test pairs of putative corresponding feature points between images, after the putative correspondences are determined, a topological equivalence test may be performed on a subset of putative correspondences to avoid forming a physically invalid transformation. After the transformation is determined, an orientation consistency test may be performed. An offset point may be determined for the feature points in the subset of putative correspondences in one of the images. Each offset point is displaced from its corresponding feature point in the direction of the orientation of that feature point. The transformation is discarded based on orientation of the feature points obtained from the feature points in the subset of putative correspondences if any one of the images being matched and its offset point differs from an estimated orientation by a predefined limit. Subsequently, motion estimation may be performed using the subset of putative correspondences which satisfy the topological equivalence test.

Motion estimation (also called geometric verification) may determine the relative differences in position between corresponding pairs of putative corresponding feature points. A geometric relationship between putative corresponding feature points may determine where in one image (e.g., the image input to be matched) a particular point is found relative to that potentially same point in the putatively matching image (i.e., a database image). The geometric relationship between many putatively corresponding feature point pairs may also be determined, thus creating a potential map between putatively corresponding feature points across images. Then the geometric relationship of these points may be compared to determine if a sufficient number of points correspond (that is, if the geometric relationship between point pairs is within a certain threshold score for the geometric relationship), thus indicating that one image may represent the same real-world physical object, albeit from a different point of view. Thus, the motion estimation may determine that the object in one image is the same as the object in another image, only rotated by a certain angle or viewed from a different distance, etc.

The above processes of image comparing feature points and performing motion estimation across putative matching images may be performed multiple times for a particular query image to compare the query image to multiple potential matches among the stored database images. Dozens of comparisons may be performed before one (or more) satisfactory matches that exceed the relevant thresholds (for both matching feature points and motion estimation) may be found. The thresholds may also include a confidence threshold, which compares each potential matching image with a confidence score that may be based on the above processing. If the confidence score exceeds a certain high threshold, the system may stop processing additional candidate matches and simply select the high confidence match as the final match. Or if, the confidence score of an image is within a certain range, the system may keep the candidate image as a potential match while continuing to search other database images for potential matches. In certain situations, multiple database images may exceed the various matching/confidence thresholds and may be determined to be candidate matches. In this situation, a comparison of a weight or confidence score may be used to select the final match, or some combination of candidate matches may be used to return results. The system may continue attempting to match an image until a certain number of potential matches are identified, a certain confidence score is reached (either individually with a single potential match or among multiple matches), or some other search stop indicator is triggered. For example, a weight may be given to each object of a potential matching database image. That weight may incrementally increase if multiple query images (for example, multiple frames from the same image stream) are found to be matches with database images of a same object. If that weight exceeds a threshold, a search stop indicator may be triggered and the corresponding object selected as the match.

Once an object is detected by object detection component 530 the system may determine which object is actually seen using object resolution component 550. Thus one component, such as object detection component 530, may detect if an object is represented in an image while another component, object resolution component 550 may determine which object is actually represented. Although illustrated as separate components, the system may also be configured so that a single component may perform both object detection and object resolution.

For example, when a database image is selected as a match to the query image, the object in the query image may be determined to be the object in the matching database image. An object identifier associated with the database image (such as a product ID or other identifier) may be used to return results to a user, along the lines of “I see you holding object X” along with other information, such giving the user information about the object. If multiple potential matches are returned (such as when the system can't determine exactly what object is found or if multiple objects appear in the query image) the system may indicate to the user that multiple potential matching objects are found and may return information/options related to the multiple objects.

In another example, object detection component 530 may determine that a type of object is represented in image data and object resolution component 550 may then determine which specific object is represented. The object resolution component 550 may also make available specific data about a recognized object to further components so that further operations may be performed with regard to the resolved object.

Object detection component 530 may be configured to process image data to detect a representation of an approximately two-dimensional (2D) object (such as a piece of paper) or a three-dimensional (3D) object (such as a face). Such recognition may be based on available stored data (e.g., 270, 570, etc.) which in turn may have been provided through an image data ingestion process managed by image data ingestion component 510. Various techniques may be used to determine the presence of features in image data. For example, one or more of a Canny detector, Sobel detector, difference of Gaussians, features from accelerated segment test (FAST) detector, scale-invariant feature transform (SIFT), speeded up robust features (SURF), color SIFT, local binary patterns (LBP), trained convolutional neural network, or other detection methodologies may be used to determine features in the image data. A feature that has been detected may have an associated descriptor that characterizes that feature. The descriptor may comprise a vector value in some implementations. For example, the descriptor may comprise data indicative of the feature with respect to many (e.g., 256) different dimensions.

In various embodiments, the object detection component 530 may be configured to detect a user or a portion of a user (e.g., head, face, hands) in image data and determine an initial position and/or orientation of the user in the image data. Various approaches can be used to detect a user within the image data. Techniques for detecting a user can sometimes be characterized as either feature-based or appearance-based. Feature-based approaches generally involve extracting features from an image and applying various rules, metrics, or heuristics to determine whether a person is present in an image. Extracted features can be low-level image features, such as points (e.g., line intersections, high variance points, local curvature discontinuities of Gabor wavelets, inflection points of curves, local extrema of wavelet transforms, Harris corners, Shi Tomasi points), edges (e.g., Canny edges, Shen-Castan (ISEF) edges), or regions of interest (e.g., blobs, Laplacian of Gaussian blobs, Difference of Gaussian blobs, Hessian blobs, maximally stable extremum regions (MSERs)). An example of a low-level image feature-based approach for user detection is the grouping of edges method. In the grouping of edges method, an edge map (generated via, e.g., a Canny detector, Sobel filter, Man-Hildreth edge operator) and heuristics are used to remove and group edges from an input image so that only the edges of the contour of a face remain. A box or ellipse is then fit to the boundary between the head region and the background. Low-level feature-based methods can also be based on gray level information or skin color. For example, facial features such as eyebrows, pupils, and lips generally appear darker than surrounding regions of the face and this observation can be used to detect a face within an image. In one such approach, a low resolution Gaussian or Laplacian of an input image is utilized to locate linear sequences of similarly oriented blobs and streaks, such as two dark blobs and three light blobs to represent eyes, cheekbones, and nose and streaks to represent the outline of the face, eyebrows, and lips. Geometric rules can be applied to analyze the spatial relationships among the blobs and streaks to verify whether a person is located in the image. Skin color can also be used as a basis for detecting and/or tracking a user because skin color comprises a limited range of the color spectrum that can be relatively efficient to locate in an image.

Extracted features can also be based on higher-level characteristics or features of a user, such as eyes, nose, and/or mouth. Certain high-level feature-based methods can be characterized as top-down or bottom-up. A top-down approach first attempts to detect a particular user feature (e.g., head or face) and then validates existence of a person in an image by detecting constituent components of that user feature (e.g., eyes, nose, mouth). In contrast, a bottom-up approach begins by extracting the constituent components first and then confirming the presence of a person based on the constituent components being correctly arranged. For example, one top-down feature-based approach is the multi-resolution rule-based method. In this embodiment, a person is detected as present within an image by generating from the image a set of pyramidal or hierarchical images that are convolved and subsampled at each ascending level of the image pyramid or hierarchy (e.g., Gaussian pyramid, Difference of Gaussian pyramid, Laplacian pyramid). At the highest level, comprising the lowest resolution image of the image pyramid or hierarchy, the most general set of rules can be applied to find whether a user is represented. An example set of rules for detecting a face may include the upper round part of a face comprising a set of pixels of uniform intensity, the center part of a face comprising a set of pixels of a second uniform intensity, and the difference between the intensities of the upper round part and the center part of the face being within a threshold intensity difference. The image pyramid or hierarchy is descended and face candidates detected at a higher level conforming to the rules for that level can be processed at finer resolutions at a lower level according to a more specific set of rules. An example set of rules at a lower level or higher resolution image of the pyramid or hierarchy can be based on local histogram equalization and edge detection, and rules for the lowest level or highest resolution image of the pyramid or hierarchy can be based on facial feature metrics. In another top-down approach, face candidates are located based on the Kanade projection method for locating the boundary of a face. In the projection method, an intensity profile of an input image is first analyzed along the horizontal axis, and two local minima are determined to be candidates for the left and right side of a head. The intensity profile along the vertical axis is then evaluated and local minima are determined to be candidates for the locations of the mouth, nose, and eyes. Detection rules for eyebrow/eyes, nostrils/nose, and mouth or similar approaches can be used to validate whether the candidate is indeed a face.

Some feature-based and appearance-based methods use template matching to determine whether a user is represented in an image. Template matching is based on matching a pre-defined face pattern or parameterized function to locate the user within an image. Templates are typically prepared manually “offline.” In template matching, correlation values for the head and facial features are obtained by comparing one or more templates to an input image, and the presence of a face is determined from the correlation values. One template-based approach for detecting a user within an image is the Yuille method, which matches a parameterized face template to face candidate regions of an input image. Two additional templates are used for matching the eyes and mouth respectively. An energy function is defined that links edges, peaks, and valleys in the image intensity profile to the corresponding characteristics in the templates, and the energy function is minimized by iteratively adjusting the parameters of the template to the fit to the image. Another template-matching method is the active shape model (ASM). ASMs statistically model the shape of the deformable object (e.g., user's head, face, other user features) and are built offline with a training set of images having labeled landmarks. The shape of the deformable object can be represented by a vector of the labeled landmarks. The shape vector can be normalized and projected onto a low dimensional subspace using principal component analysis (PCA). The ASM is used as a template to determine whether a person is located in an image. The ASM has led to the use of Active Appearance Models (AAMs), which further include defining a texture or intensity vector as part of the template. Based on a point distribution model, images in the training set of images can be transformed to the mean shape to produce shape-free patches. The intensities from these patches can be sampled to generate the intensity vector, and the dimensionality of the intensity vector may be reduced using PCA. The parameters of the AAM can be optimized and the AAM can be fit to an object appearing in the new image using, for example, a gradient descent technique or linear regression.

Various other appearance-based methods can also be used to locate whether a user is represented in an image. Appearance-based methods typically use classifiers that are trained from positive examples of persons represented in images and negative examples of images with no persons. Application of the classifiers to an input image can determine whether a user exists in an image. Appearance-based methods can be based on PCA, neural networks, support vector machines (SVMs), naïve Bayes classifiers, the Hidden Markov model (HMM), inductive learning, adaptive boosting (Adaboost), among others. Eigenfaces are an example of an approach based on PCA. PCA is performed on a training set of images known to include faces to determine the eigenvectors of the covariance matrix of the training set. The Eigenfaces span a subspace called the “face space.” Images of faces are projected onto the subspace and clustered. To detect a face of a person in an image, the distance between a region of the image and the “face space” is computed for all location in the image. The distance from the “face space” is used as a measure of whether image subject matter comprises a face and the distances from “face space” form a “face map.” A face can be detected from the local minima of the “face map.”

Neural networks are inspired by biological neural networks and consist of an interconnected group of functions or classifiers that process information using a connectionist approach. Neural networks change their structure during training, such as by merging overlapping detections within one network and training an arbitration network to combine the results from different networks. Examples of neural network-based approaches include Rowley's multilayer neural network, the autoassociative neural network, the probabilistic decision-based neural network (PDBNN), the sparse network of winnows (SNoW). A variation of neural networks are deep belief networks (DBNs) which use unsupervised pre-training to generate a neural network to first learn useful features, and training the DBN further by backpropagation with trained data.

Support vector machines (SVMs) operate under the principle of structural risk minimization, which aims to minimize an upper bound on the expected generalization error. An SVM seeks to find the optimal separating hyperplane constructed by support vectors, and is defined as a quadratic programming problem. The Naïve Bayes classifier estimates the local appearance and position of face patterns at multiple resolutions. At each scale, a face image is decomposed into subregions and the subregions are further decomposed according to space, frequency, and orientation. The statistics of each projected subregion are estimated from the projected samples to learn the joint distribution of object and position. A face is determined to be within an image if the likelihood ratio is greater than the ratio of prior probabilities, i.e.,

$$\frac{P ( image \vert object )}{P ( image \vert non - object )} > \frac{P ( non - object )}{P ( object )} .$$

In HMM-based approaches, face patterns are treated as sequences of observation vectors each comprising a strip of pixels. Each strip of pixels is treated as an observation or state of the HMM and boundaries between strips of pixels are represented by transitions between observations or states according to statistical modeling. Inductive learning approaches, such as those based on Quinlan's C4.5 algorithm or Mitchell's Find-S algorithm, can also be used to detect the presence of persons in images.

AdaBoost is a machine learning boosting algorithm which finds a highly accurate hypothesis (i.e., low error rate) from a combination of many “weak” hypotheses (i.e., substantial error rate). Given a data set comprising examples within a class and not within the class and weights based on the difficulty of classifying an example and a weak set of classifiers, AdaBoost generates and calls a new weak classifier in each of a series of rounds. For each call, the distribution of weights is updated that indicates the importance of examples in the data set for the classification. On each round, the weights of each incorrectly classified example are increased, and the weights of each correctly classified example is decreased so the new classifier focuses on the difficult examples (i.e., those examples have not been correctly classified). An example of an AdaBoost-based approach is the Viola-Jones detector.

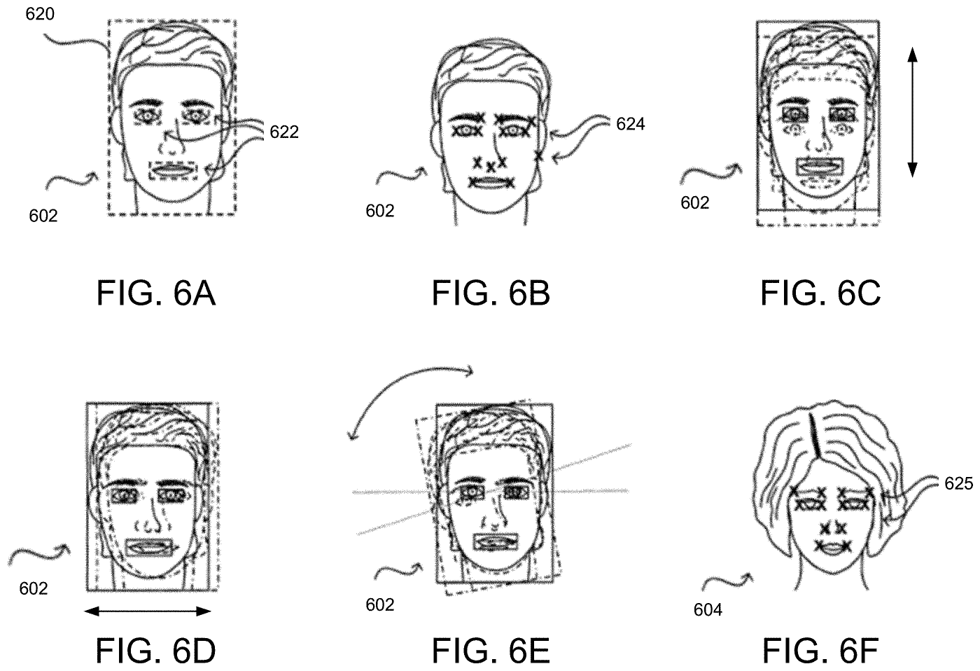

After at least a portion of a user has been detected in image data captured by a computing device, approaches in accordance with various embodiments track the detected portion of the user, for example using object tracking component 560. The object tracking component 560, gaze detector 565, or other component(s), may use user recognition data 1895 or other information related to the user recognition component to identify and/or track a user using image data. FIGS. 6A-6F illustrate certain approaches that can be utilized for detecting and tracking a user's face in accordance with various embodiments. FIG. 6A illustrates an example wherein the approximate position and orientation of the head of a user 602 has been determined and a virtual “box” 620 is placed around the user's head using one or more of the various user detection processes discussed herein. A similar or different approach can also be used to determine an approximate location and area 622 of each of the user's eyes (or in some cases the eyes in tandem) and mouth or other facial features. By determining the location of the user's eyes and mouth as part of facial detection, advantages may be obtained as it can be more likely that the image determined to be the user's face actually includes the user's face, and it can be determined that the user is in front of the device and that the user is looking at the device. Further, the relative movement of the user's eyes and mouth can be easier to detect than the overall movement of the user's face when the user is performing motions such as nodding or shaking the head back and forth.

Various other approaches can also be used to track the user. For example, FIG. 6B illustrates an example wherein various features on a user's face are identified and assigned a point 624 in the image. The system thus can detect various aspects of user facial features and can determine changes such as movement or change in shape or expression. Such an approach can provide advantages over the general approach of FIG. 6A in certain situations, as various points along a facial feature can be determined, such as the end points and at least one center point of a user's mouth. Accordingly, expressions such as a smile or frown can be captured even though the overall position of the user's mouth or face did not move.

Once the facial features of a user are detected, relative motion or changes in facial expression can be tracked and utilized as input in accordance with various embodiments. For example, FIG. 6C illustrates an example where the user's head 602 is moving up and down with respect to the viewable area of the imaging element. As discussed, this could be the result of the user shaking his or her head, or the user moving the device up and down, etc. FIG. 6D illustrates a similar example wherein the user is moving right to left relative to the device, through movement of the user, the device, or both. As can be seen, each movement can be tracked as a vertical or horizontal movement, respectively, and each can be treated differently as an input to perform a specified function. As should be understood, various embodiments also can detect diagonal or other such movements. FIG. 6E further illustrates an example wherein the user tilts the device and/or the user's head, and the relative change in eye position is detected as a rotation. In some systems, a “line” that corresponds to the relative position of the eyes (or other facial features such as eyebrows, hairline, mouth, chin, ears, etc.) can be monitored, and a shift in angle of this line can be compared to an angle threshold to determine when the rotation should be interpreted as input.

FIG. 6F illustrates another advantage of using an approach such as that described with respect to FIG. 6B to determine the position of various features on a user's face. In this example, it can be seen that the features of a head of a second user 604 have a different relative position and separation. Thus, a computing device also can not only determine positions and changes of facial features for a specific user, but can distinguish between different users. Also, the device can be configured to detect how close a user is to the device based on, for example, the amount and ratio of separation of various features 625, such that the device can detect movement towards, and away from, the device. This can help to improve the accuracy of facial tracking.

In some embodiments, information from other sensors of the computing device, such as information about the motion of the computing device may be used to enhance the head/face tracking, or other object tracking being performed by the device. For example, the computing device may include one or more cameras capable of capturing images of the user's head or other features (e.g., hands, fingers, facial features, etc.). The image data can be processed to perform facial recognition or gesture recognition for gestures that do not require a physical touch of the device, among other functionality. Conventionally, user detection and/or tracking can be computationally intensive and it may be desirable to optimize these processes by using the information about the motion of the computing device. For instance, if the computing device detects, based on inertial sensor data (e.g., accelerometer, gyroscope, inclinometer, and/or magnetometer), that the user has rotated the computing device such that the user's face is not likely to be within the view of the camera, the computing device may stop the process of user detection and/or tracking to conserve resources (e.g., CPU utilization, power, etc.). Similarly, if the device determines that the user is on a moving bus (e.g., as determined by a mobile payment application for bus fare) or other changing environment where the amount of light is periodically changing (e.g., as determined by an ambient light sensor), the computing device may choose to continue executing the head tracking process even though the user's face (or other features) may become undetectable during certain time intervals due to lack of light. In this manner, the computing device may utilize information about the motion of the device and other context to assist the processes for user detection and tracking.

Object tracking component 560 may also track other objects represented in image data. An object identified in image data (for example by object detection component 530) may appear in different position(s) in image data captured by a camera of device 110. Object tracking component 560 may track the object across image data and may (along with other component(s) of the system) attempt to determine a relative position of the object to the device 110 (or other reference point) over time using various techniques.

Object tracking component 560 may also include a gaze detection component 565. The gaze detection component 565 may also be located elsewhere in the system design. The gaze detection component 565 may include a classifier or other component (for example including one or more trained model(s)) that is configured to track the gaze of a user using image data and/or feature data corresponding to image data. The gaze detection component 565 may output data indicating that a user is looking at a device or looking elsewhere (for example at another user). If operated on device 110, the gaze detection component 565 may process image data (which may including raw image data captured by a camera or may include feature data representing raw image data) to determine that the user is gazing at a camera of the device. If operated on another device, the gaze detection component 565 may process image data to determine a user is looking at device 110, for example looking at device 110 while speaking an utterance. In this manner processing by a second device may be used to determine that a user is looking at a first device while speaking to the first device. Thus, for example, in a smart-home situation image data from a camera removed from a speech-capture device (e.g., device 110) may be used to determine a user was looking at the speech-capture device when speaking. Data from the gaze detector 565 may be used, for example, by system directed input detector 385.

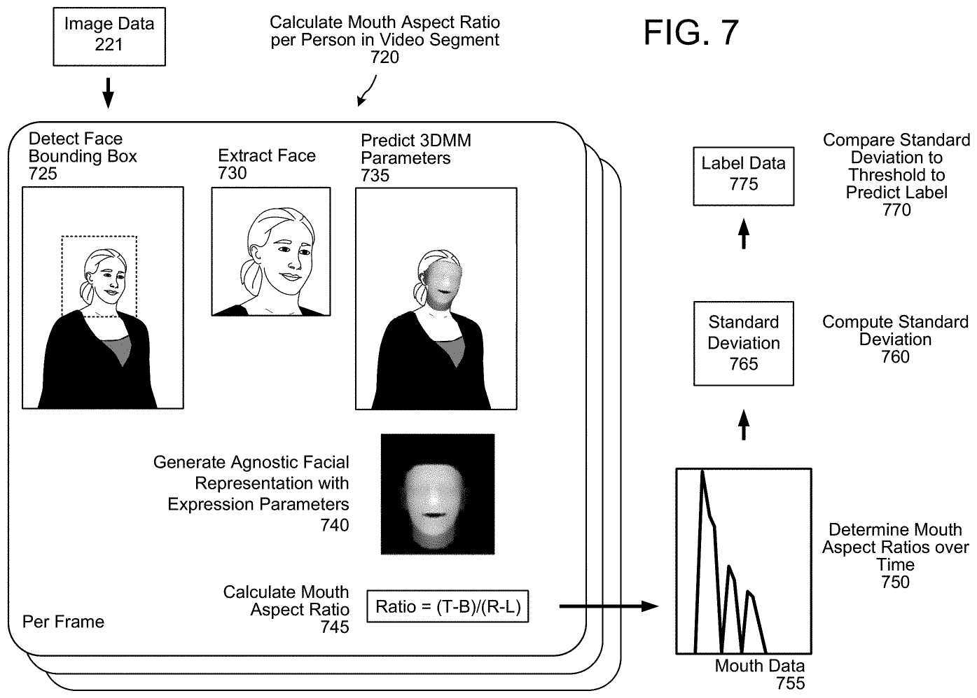

FIG. 7 is a conceptual diagram illustrating an example of performing active speaker detection by calculating a mouth aspect ratio, according to embodiments of the present disclosure. As illustrated in FIG. 7, the system 100 may perform facial analysis to generate a three-dimensional (3D) model of the user's face. For example, the system 100 may process image data 221 to calculate mouth aspect ratios per person in a video segment 720.

As illustrated in FIG. 7, the system 100 process individual video frames of the image data 221. For example, the system 100 may select an individual video frame of the image data 221, detect (725) a face bounding box corresponding to a portion of the video frame representing a face, and extract (730) the face. The system 100 may input the extracted face to a model configured to output 3D Morphable Model (3DMM) parameters for a dense 3D mesh representation of the face. As used herein, the 3D mesh representation may be referred to as a mesh model, and/or the like without departing from the disclosure. In some examples, the model may be a deep neural network (DNN) model that is trained to take the output of a face detector (e.g., a portion of image data cropped around a face) as input and directly output the 3DMM parameters, although the disclosure is not limited thereto.

As illustrated in FIG. 7, the system 100 may predict (735) 3DMM parameters corresponding to the face. The 3DMM parameters may include shape parameters (e.g., parameters representing a face shape), expression parameters (e.g., parameters representing facial expression(s)), a scalar parameter, a rotation vector, a translation vector, and/or additional parameters corresponding to the face. For example, the shape parameters enable the system 100 to model the user's specific facial shape, the expression parameters enable the system 100 to model the user's facial expression(s), and the scalar parameter, the rotation vector, and the translation vector modify the size, rotation, and position of the mesh model, respectively.

To perform active speaker detection, the system 100 may generate (740) an agnostic facial representation using the expression parameters. Based on facial landmarks (e.g., positions of a top lip and a bottom lip represented in the agnostic facial representation), the system 100 may calculate (745) a mouth aspect ratio by dividing a mouth height by a mouth width (e.g., (T-B)/(R-L), as described in greater detail below with regard to FIG. 10A.

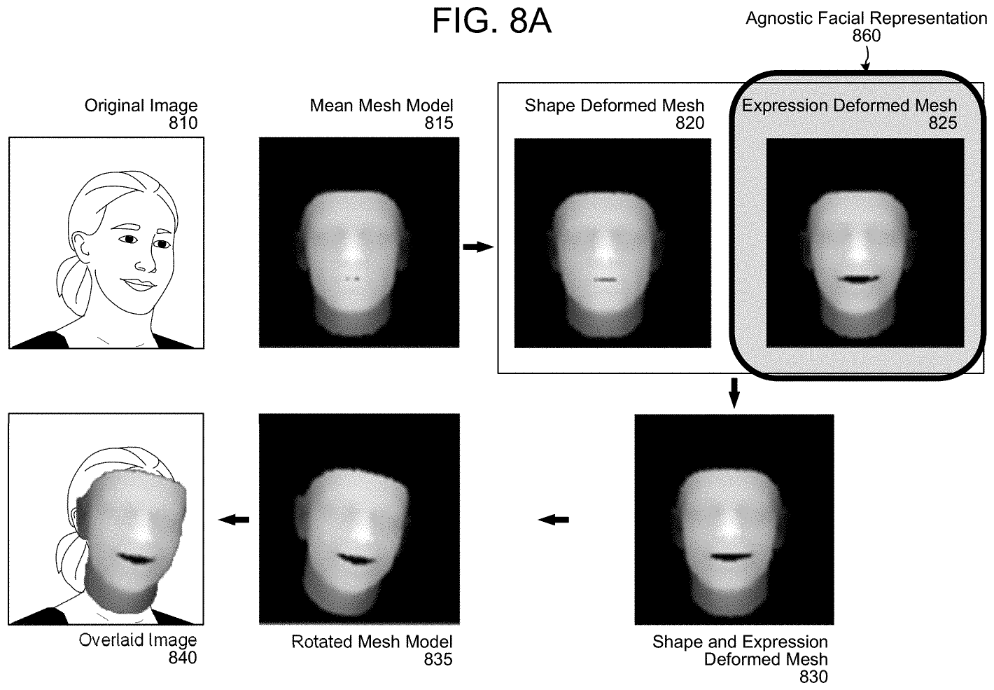

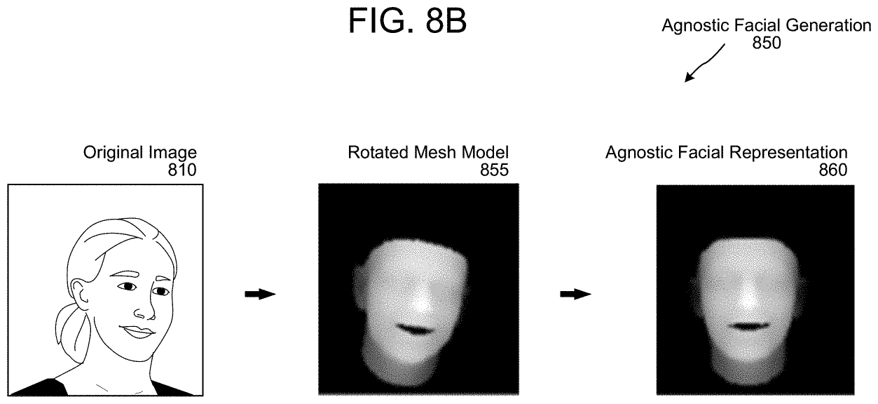

Finally, the system 100 may determine (750) mouth data 755 representing mouth aspect ratios over time, may compute (760) a standard deviation 765 corresponding to the mouth data 755, and may compare (770) the standard deviation to a threshold to predict a label. Thus, the system 100 may generate label data 775 indicating whether a user is speaking for individual video frame(s) of the image data 221, although the disclosure is not limited thereto. Additional details about generating an agnostic facial representation, calculating the mouth aspect ratio, computing the standard deviation, and/or generating the label data are described below with regard to FIGS. 8-4B.

FIGS. 8A-8B are conceptual diagrams illustrating examples of generating a mesh model having an agnostic facial representation, according to embodiments of the present disclosure. To accurately measure mouth movements despite changes in facial shape between individual users and/or rotational movement of the user, the system 100 may perform facial analysis to generate a three-dimensional (3D) model of the user's face. For example, the system 100 may input image data representing a face to a model configured to output 3D Morphable Model (3DMM) parameters for a dense 3D mesh representation of the face. As used herein, the 3D mesh representation may be referred to as a mesh model, although the disclosure is not limited thereto.

In some examples, the model may be a deep neural network (DNN) model that is trained to take the output of a face detector (e.g., a portion of image data cropped around a face) as input and directly output the 3DMM parameters, although the disclosure is not limited thereto. To illustrate this concept, FIG. 8A illustrates an example of fitting a 3D mesh model on a two-dimensional (2D) image using the output from the DNN model. For example, FIG. 8A illustrates an original image 810 that is input to the DNN model and applied to a neutral mesh model, illustrated as mean mesh model 815. The mean mesh model 815 is a baseline or average mesh model that can be modified using shape parameters and/or expression parameters to model the user's face. For example, shape deformed mesh 820 illustrates an example of the mean mesh model 815 being deformed to match only a shape of the user's face, expression deformed mesh 825 illustrates an example of the mean mesh model 815 being deformed to match only facial expressions of the user's face, and shape and expression deformed mesh 830 illustrates an example of the mean mesh model 815 being deformed to match both a shape of the user's face and facial expressions of the user's face.

As illustrated in FIG. 8A, the shape and expression deformed mesh 830 can be modified to generate rotated mesh model 835 that corresponds to the original image 810. For example, the shape and expression deformed mesh 830 may be modified using a scalar parameter, a rotation vector, a translation vector, and/or additional parameters such that the rotated mesh model 835 corresponds to the original face represented in the original image 810. Thus, overlaid image 840 illustrates an example of the rotated mesh model 835 overlaid on top of the original image 810 to show how the mesh model may correspond to the original face.

The 3DMM parameters used to generate a representation of the face may include shape parameters (e.g., parameters representing a face shape), expression parameters (e.g., parameters representing facial expression(s)), a scalar parameter, a rotation vector, a translation vector, and/or additional parameters corresponding to the face. For example, the shape parameters enable the system 100 to model the user's specific facial shape (e.g., shape deformed mesh 820), the expression parameters enable the system 100 to model the user's facial expression(s) (e.g., expression deformed mesh 825), and a combination of the shape parameters and the expression parameters enable the system 100 to model the user's specific shape with the user's facial expression(s) (e.g., shape and expression deformed mesh 830).

While FIG. 8A conceptually illustrates how a device may model the original face in the original image 810, the device 110 only generates a mesh model using the expression parameters (e.g., without the shape parameters). Thus, the expression deformed mesh 825 corresponds to an agnostic facial representation 860 used to determine the mouth aspect ratio.

As illustrated in FIG. 8B, the device 110 may perform agnostic facial generation 850 to generate the agnostic facial representation 860. For example, the device 110 may process the original image 810 to generate a portion of the 3DMM parameters, such as the expression parameters along with pose parameters (e.g., the scalar parameter, the rotation vector, the translation vector, and/or the like). While the device 110 does not generate a mesh model using the portion of the 3DMM parameters, FIG. 8B illustrates that the portion of the 3DMM parameters may correspond to a rotated mesh model 855. However, unlike the rotated mesh model 835, the rotated mesh model 855 is not generated using the shape parameters, as the portion of the 3DMM parameters does not include the shape parameters.

After generating the portion of the 3DMM parameters, the device 110 may remove the rotation and/or other pose parameters, as well as perform de-identification to generate only the expression parameters. The device 110 may generate a mesh model using the expression parameters, represented in FIG. 8B as an agnostic facial representation 860. However, the disclosure is not limited thereto, and in some examples the device 110 may only determine the expression parameters and/or generate a portion of the mesh model without departing from the disclosure.

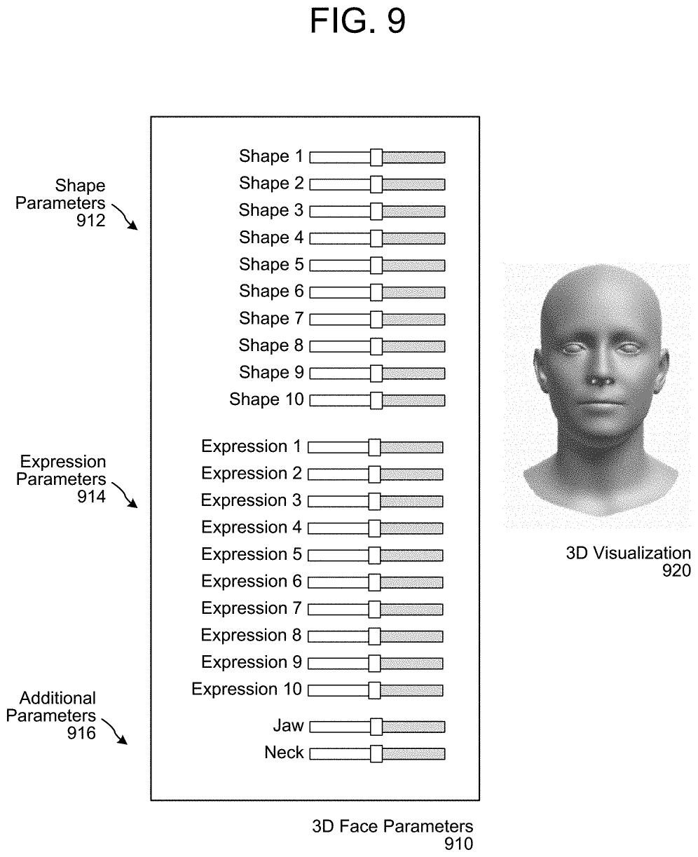

FIG. 9 is a conceptual diagram illustrating an example of shape parameters and expression parameters used to generate a mesh model, according to embodiments of the present disclosure. As illustrated in FIG. 9, the system 100 may use 3D face parameters 910 to generate a 3D visualization 920 of the user's face. In the example illustrated in FIG. 9, the 3D face parameters 910 include shape parameters 912, expression parameters 914, and additional parameters 916, although the disclosure is not limited thereto. While FIG. 9 illustrates an example in which the 3D face parameters 910 include a certain number of shape parameters 912 and/or expression parameters 914, the disclosure is not limited thereto and the number of parameters may vary without departing from the disclosure.

As described above, the system 100 may generate an agnostic facial representation using only the expression parameters in order to generate a neutral mesh model with uniform identity and pose that represents the user's mouth movements. This explicitly removes information that would make it difficult to compare face movements between individual users and/or could be used to individually identify the user. Using the neutral mesh model, the system may measure the user's mouth movements over time, such as by determining a mouth aspect ratio between a mouth height and a mouth width. Based on an amount of variation in the mouth movements, the system can determine whether the user is speaking and detect an utterance.

FIGS. 10A-10B are conceptual diagrams illustrating examples of performing facial measurements and calculating aspect ratios, according to embodiments of the present disclosure. As illustrated in FIG. 10A, the system 100 may process first image data 1010 to estimate first positions for first lip landmarks 1015 associated with a first video frame, and may process second image data 1020 to estimate second positions for second lip landmarks 1025 associated with a second video frame.

In the example illustrated in FIG. 10A, the first lip landmarks 1015 correspond to four positions in the user's face, such as a top lip position (e.g., T), a bottom lip position (e.g., B), a left lip position (e.g., L), and a right lip position (e.g., R). As described in greater detail above with regard to FIGS. 1 and 7, the system 100 may process the first image data 1010 to determine first 3D Morphable Model (3DMM) parameters and may use first expression parameters from the first 3DMM parameters to generate a first mesh model that represents a first agnostic facial representation. Thus, while FIG. 10A illustrates the first lip landmarks 1015 relative to the user's face represented in the first image data 1010, the actual coordinate values used to determine the first positions of the first lip landmarks 1015 are determined based on the first mesh model (e.g., agnostic facial representation 860. As the first mesh model is generated using only the first expression parameters (e.g., ignoring shape parameter(s), scalar parameter(s), rotation vector(s), translation vector(s), etc.), the first positions of the first lip landmarks 1015 vary based on the facial expression(s) of the user 5 but do not vary based on head movement(s) (e.g., a relative size of the face, rotation of the face, etc.) and/or the like.

To determine the first positions of the first lip landmarks 1015, the system 100 may generate the first mesh model and determine coordinate values corresponding to the mouth represented in the first mesh model. For example, the system 100 may determine first coordinate values corresponding to a position along the top lip in the first mesh model (represented in FIG. 10A as T), second coordinate values corresponding to a position along the bottom lip in the first mesh model (represented in FIG. 10A as B), third coordinate values corresponding to an intersection between the top lip and the bottom lip on the left-side of the first mesh model (represented in FIG. 10A as L), and fourth coordinate values corresponding to an intersection between the top lip and the bottom lip on the right-side of the first mesh model (represented in FIG. 10A as R). However, the disclosure is not limited thereto and the exact positions of the first lip landmarks 1015 may vary without departing from the disclosure. For example, in some examples the first coordinate values may correspond to a center of the top lip in the first mesh model, while in other examples the first coordinate values may correspond to a highest position of the top lip in the first mesh model (e.g., highest point along the vertical axis) without departing from the disclosure. Similarly, in some examples the second coordinate values may correspond to a center of the bottom lip in the first mesh model, while in other examples the second coordinate values may correspond to a lowest position of the bottom lip in the first mesh model (e.g., lowest point along the vertical axis) without departing from the disclosure. This applies to the left lip position and the right lip position as well, such that the third coordinate values may correspond to the left-most position of the mouth represented in the first mesh model (e.g., lowest point along the horizontal axis) and the fourth coordinate values may correspond to the right-most position of the mouth represented in the mesh model (e.g., highest point along the horizontal axis) without departing from the disclosure.

Using the first positions of the first lip landmarks 1015, the system 100 may perform an aspect ratio calculation 1030 to determine a first mouth aspect ratio value corresponding to the first image data 1010. For example, the system 100 may determine the first mouth aspect ratio value by calculating a ratio between a height of the mouth (e.g., mouth height, or T-B) and a width of the mouth (e.g., mouth width, or R-L) as represented in the first mesh model. In some examples, the system 100 may determine a first distance value by subtracting the second coordinate values from the first coordinate values, with the first distance value representing a first mouth height associated with the first mesh model. Similarly, the system 100 may determine a second distance value by subtracting the third coordinate values from the fourth coordinate values, with the second distance value representing a first mouth width associated with the first mesh model. Finally, the system 100 may determine the first mouth aspect ratio value by dividing the first distance value by the second distance value (e.g., height/width). However, the disclosure is not limited thereto and the system 100 may determine the first mouth aspect ratio value using any techniques without departing from the disclosure.

As the first mesh model represents a three-dimensional agnostic facial representation, in some examples the coordinate values corresponding to the first lip landmarks 1015 are 3D coordinates (e.g., [x,y,z]). Thus, the first distance value between the first coordinate values (e.g., [x₁,y₁,z₁]) and the second coordinate values (e.g., [x₂,y₂,z₂]) may be calculated using Equation [1], shown below:

d=\sqrt{(x₁−x₂)²+(y₁−y₂)²+(z₁−z₂)²} [1]

However, the disclosure is not limited thereto and in other examples the coordinate values corresponding to the first lip landmarks 1015 may be 2D coordinates (e.g., [x,y]), the first distance value may be calculated using only the vertical component of the coordinate values (e.g., first distance=y₁−y₂), and/or the like without departing from the disclosure. Similarly, the second distance value between the third coordinate values (e.g., [x₃,y₃,z₃]) and the fourth coordinate values (e.g., [x₄,y₄,z₄]) may be calculated using Equation [1], although the disclosure is not limited thereto and the third coordinate values and the fourth coordinate values may be 2D coordinates (e.g., [x,y]), the second distance value may be calculated using only the horizontal component of the coordinate values (e.g., second distance=x₄−x₃), and/or the like without departing from the disclosure.

As used herein, the mouth height represents vertical dimensions of an opening created by the mouth and may refer to an inner mouth height (e.g., first distance between a bottom of the top lip and a top of the bottom lip), an outer mouth height (e.g., second distance between a top of the top lip and a bottom of the bottom lip), and/or the like without departing from the disclosure. Similarly, the mouth width represents horizontal dimensions of the opening created by the mouth and may refer to an inner mouth width (e.g., third distance between a right side of a first intersection of the top lip and the bottom lip and a left side of a second intersection of the top lip and the bottom lip), an outer mouth width (e.g., fourth distance between a left side of the first intersection and a right side of the second intersection), and/or the like without departing from the disclosure.

The system 100 may repeat the steps described above to determine a second mouth aspect ratio value corresponding to the second image data 1020. For example, the system 100 may process the second image data 1020 to determine second 3DMM parameters, may use second expression parameters from the second 3DMM parameters to generate a second mesh model that represents a second agnostic facial representation, may use the second mesh model to determine second positions of the second lip landmarks 1025 (e.g., a second set of coordinate values), and may perform the aspect ratio calculation 1030 to determine a second mouth aspect ratio value corresponding to the second image data 1020.

While FIG. 10A illustrates an example of the system 100 using four lip landmarks to determine the mouth aspect ratio, the disclosure is not limited thereto. Instead, the system 100 may use any number of lip landmarks and/or other facial landmarks to determine the mouth aspect ratio without departing from the disclosure. Additionally or alternatively, while FIG. 10A illustrates an example of the system 100 using the mouth aspect ratio as a proxy for to determine whether the user 5 is speaking, the disclosure is not limited thereto and the system 100 may use other facial measurements to determine whether the user 5 is speaking without departing from the disclosure. For example, the system 100 may determine one or more facial measurements using lip landmark(s) and/or facial landmark(s), determine whether the user 5 is speaking based on two or more facial measurements, and/or the like without departing from the disclosure.

FIG. 10B illustrates examples of facial measurements 1040. For example, the system 100 may determine the mouth aspect ratio using the aspect ratio calculation 1030 illustrated in FIG. 10A, which divides the mouth height by the mouth width to determine a single number that represents how much the mouth is opening. Thus, the mouth aspect ratio corresponds to a lower number when the mouth is closed (e.g., not talking) and a higher number when the mouth is open (e.g., talking). Alternatively, the system 100 may determine a mouth area using mouth area calculation 1045 illustrated in FIG. 10B, which multiplies the mouth height by the mouth width to determine a single number that represents how much the mouth is opening. Thus, the mouth area corresponds to a lower number when the mouth is closed (e.g., not talking) and a higher number when the mouth is open (e.g., talking). Additionally or alternatively, in some examples the system 100 may determine whether the user 5 is speaking using only the bottom lip coordinates (e.g., B), as illustrated by bottom lip measurement 1050, without departing from the disclosure. However, the disclosure is not limited thereto and the system 100 may perform facial measurement 1060 using any of the expression parameters 914 to generate measurement data 1065 without departing from the disclosure.

While FIG. 10A illustrates an example of the system 100 determining a single variable (e.g., mouth aspect ratio), the disclosure is not limited thereto. In some examples the system 100 may generate multiple variables without departing from the disclosure. For example, the system 100 may determine a first mouth aspect ratio (e.g., using an inner mouth height and inner mouth width) and a second mouth aspect ratio (e.g., using an outer mouth height and an outer mouth width), although the disclosure is not limited thereto. The system 100 may process the multiple variables to generate a single standard deviation (e.g., determining difference values between the second mouth aspect ratio and the first mouth aspect ratio and then calculating the standard deviation of the difference values) or to generate multiple standard deviations (e.g., determining a first standard deviation for the first mouth aspect ratio and a second standard deviation for the second mouth aspect ratio), although the disclosure is not limited thereto. In some examples, the system 100 may include a classifier configured to process multiple facial measurements (e.g., first mouth aspect ratio, second mouth aspect ratio, mouth width, mouth height, and/or the like) although the disclosure is not limited thereto.

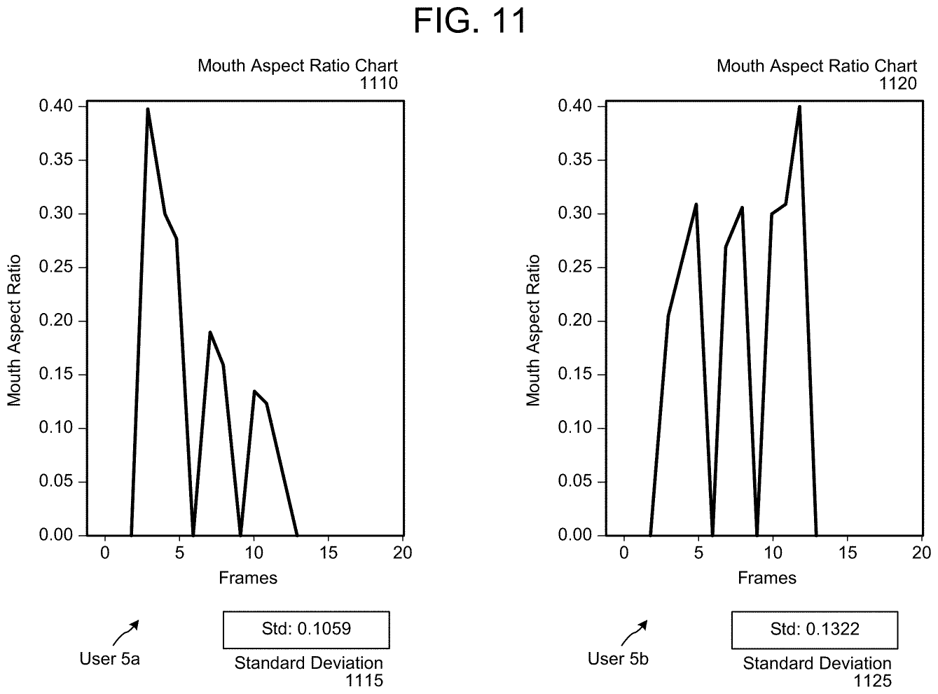

FIG. 11 is a conceptual diagram illustrating examples of mouth aspect ratio values and corresponding standard deviations associated with two different faces, according to embodiments of the present disclosure. As illustrated in FIG. 11, a first mouth aspect ratio chart 1110 illustrates a first series of mouth aspect ratios associated with a first user 5a, while a second mouth aspect ratio chart 1120 illustrates a second series of mouth aspect ratios associated with a second user 5b. As shown in the first mouth aspect ratio chart 1110 and the second mouth aspect ratio chart 1120, a vertical axis indicates a value of the mouth aspect ratio while a horizontal axis indicates a video frame within the image data that is associated with the mouth aspect ratio value.

As illustrated in FIG. 11, the first mouth aspect ratio chart 1110 illustrates an example in which the mouth aspect ratio varies slightly over time, with three separate peaks but only one peak corresponding to a mouth aspect ratio over 0.30. This may correspond to the first user 5a having only slight mouth movements and the mouth being partially closed. In contrast, the second mouth aspect ratio chart 1120 illustrates an example in which the mouth aspect ratio varies more significantly, with three separate peaks that all correspond to a mouth aspect ratio over 0.30. Thus, this may correspond to the second user 5b having more noticeable mouth movements and the mouth being opened three separate times. Comparing the second mouth aspect ratio chart 1120 to the first mouth aspect ratio chart 1110 qualitatively, it appears that the second mouth aspect ratio chart 1120 corresponds to more mouth movements than the first mouth aspect ratio chart 1110.

To determine which user is speaking, the system 100 may compare the two charts quantitatively based on an amount of variation. For example, the system 100 may determine a first amount of variation in the first mouth aspect ratios for the first user 5a and a second amount of variation in the second mouth aspect ratios for the second user 5b. As illustrated in FIG. 11, the system 100 may determine a first standard deviation 1115 (e.g., 0.1059) corresponding to the first mouth aspect ratio chart 1110 and a second standard deviation 1125 (e.g., 0.1322) corresponding to the second mouth aspect ratio chart 1120. However, the disclosure is not limited thereto, and the system 100 may determine a standard deviation, a variance, and/or other statistical measurements without departing from the disclosure.

The system 100 may use the first amount of variation as a way of determining whether the first user 5a is opening and closing the user's mouth, which may correspond to the first user 5a speaking. In some examples, the system 100 may compare the first standard deviation 1115 to a threshold and determine whether the first standard deviation 1115 satisfies the threshold. For example, the first standard deviation 1115 may be above a threshold value, below a threshold value, within a range of values, and/or the like without departing from the disclosure. If the first standard deviation 1115 satisfies the threshold, the system 100 may determine that the first user 5a is speaking during a first time range associated with the first mouth aspect ratio chart 1110. For example, the system 100 may generate label(s) indicating that the first user 5a is speaking for individual video frames that are associated with the first standard deviation 1115. However, if the first standard deviation 1115 does not satisfy the threshold, the system 100 may determine that the first user 5a is not speaking during the first time range and may generate label(s) indicating that the first user 5a is not speaking. Additionally or alternatively, the system 100 may perform similar steps to determine whether the second user 5b is speaking during a second time range associated with the second mouth aspect ratio chart 1120. For example, the system 100 may compare the second standard deviation 1125 to the threshold and determine whether the second standard deviation 1125 satisfies the threshold and/or generate label(s) indicating whether the second user 5b is speaking.

In other examples, the system 100 may compare the first standard deviation 1115 to the second standard deviation 1125 and determine whether the first user 5a is speaking or the second user 5b is speaking without departing from the disclosure. For example, the system 100 may detect an utterance during a fixed time range and determine that only the first user 5a and the second user 5b are represented in image data corresponding to the fixed time range. Thus, the system 100 may determine that the second standard deviation 1125 is greater than the first standard deviation 1115 and determine that the second user 5b is the one speaking during the fixed time range.

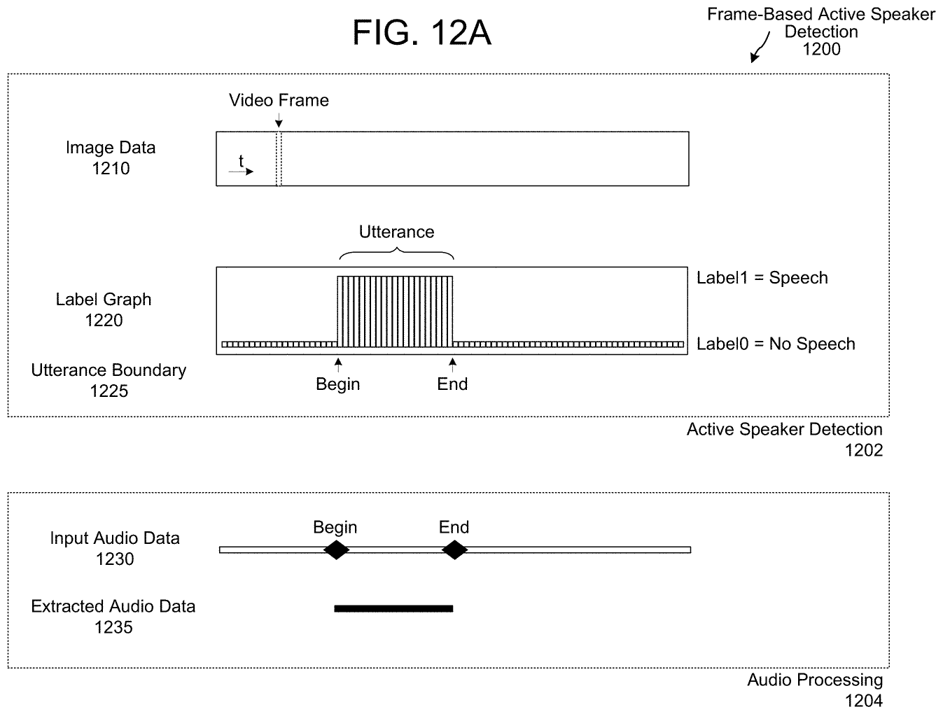

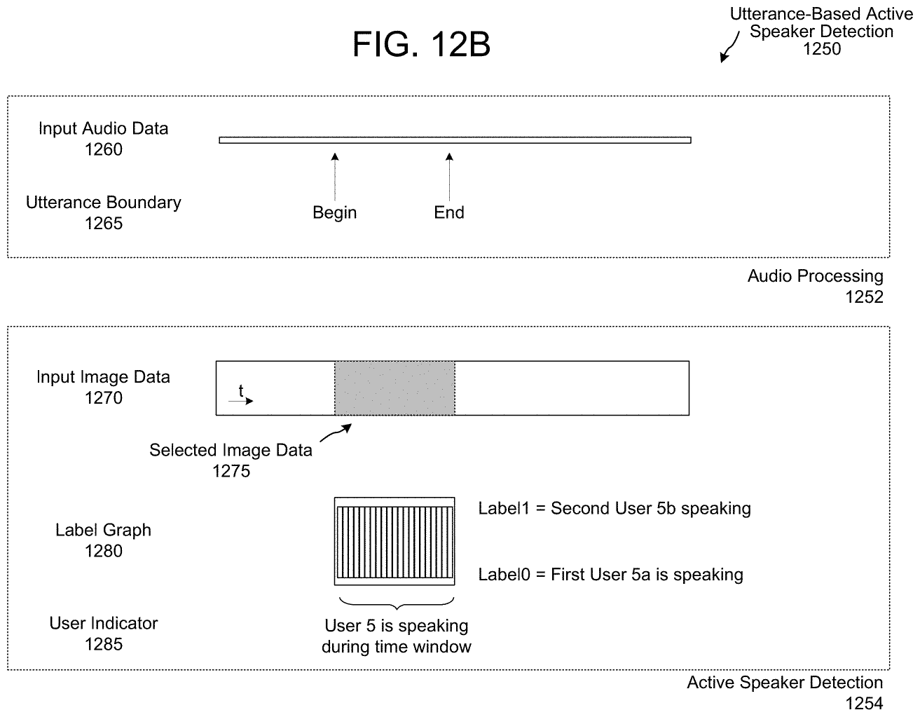

FIG. 12A is a conceptual diagram illustrating an example of a frame-based method for performing active speaker detection, according to embodiments of the present disclosure. As illustrated in FIG. 12A, in some examples the system 100 may perform frame-based active speaker detection 1200 to detect an utterance. For example, the system 100 may continuously process input image data to determine whether a user is speaking and/or to determine a boundary (e.g., beginning and/or ending) associated with an utterance.

As illustrated in FIG. 12A, the frame-based active speaker detection 1200 begins with the system 100 performing active speaker detection 1202 on image data 1210. For example, the system 100 may perform the steps described above with regard to FIG. 7 to generate label data corresponding to the image data 1210, illustrated as label graph 1220. In some examples, the system 100 may generate an individual label for each video frame in the image data 1210, although the disclosure is not limited thereto. The label graph 1220 illustrates an example in which the system 100 determines label data that includes a first label (e.g., Label0=No Speech) for video frames that are not associated with an utterance and a second label (e.g., Label1=Speech) for video frames that are associated with an utterance.

Using the label data, the system 100 may determine an utterance boundary 1225, such as identifying a beginning and/or end of an utterance. In some examples, the system 100 may perform the active speaker detection 1202 to determine a beginning of the utterance and may perform other techniques to detect the ending of the utterance without departing from the disclosure. For example, the system 100 may generate the label data (e.g., label graph 1220), detect a beginning of the utterance based on the label data (e.g., first portion of the label data corresponding to “Begin” as illustrated in FIG. 12A), and generate a first utterance boundary 1225a indicating that an utterance has begun. In response to the first utterance boundary 1225a, the system 100 may generate audio data corresponding to the utterance and perform audio processing to determine an end of the utterance.

In other examples, the system 100 may detect a beginning of the utterance (e.g., using audio processing and/or active speaker detection 1202) at a first time and then separately perform the active speaker detection 1202 to determine an ending of the utterance. For example, while generating the audio data corresponding to the utterance, the system 100 may generate the label data (e.g., label graph 1220), detect an ending of the utterance based on the label data (e.g., second portion of the label data corresponding to “End” as illustrated in FIG. 12A), and generate a second utterance boundary 1225b indicating that the utterance has ended. In response to the second utterance boundary 1225b, the system 100 may stop generating the audio data and may perform additional processing to detect a voice command represented in the audio data.

Additionally or alternatively, the system 100 may perform the active speaker detection 1202 to determine a beginning and an ending of the utterance without departing from the disclosure. For example, the system 100 may generate the label data (e.g., label graph 1220), detect the beginning of the utterance based on the label data (e.g., first portion of the label data corresponding to “Begin” as illustrated in FIG. 12A), and detect an ending of the utterance based on the label data (e.g., second portion of the label data corresponding to “End” as illustrated in FIG. 12A). The system 100 may then generate the utterance boundary 1225, which indicates both the beginning and the ending of the utterance, and use the utterance boundary 1225 to extract a portion of audio data that represents the utterance.

As illustrated in FIG. 12A, the system 100 may perform active speaker detection 1202 to generate the utterance boundary 1225 and then perform audio processing 1204 to generate extracted audio data 1235 corresponding to the utterance. In some examples, the system 100 may only begin generating input audio data 1230 in response to the utterance boundary 1225 indicating that an utterance is detected. The disclosure is not limited thereto, however, and in other examples the system 100 may capture the input audio data 1230 continuously and only generate the extracted audio data 1235 in response to the utterance boundary 1225 without departing from the disclosure.

While FIG. 12A illustrates an example of the system 100 performing active speaker detection prior to performing audio processing, the disclosure is not limited thereto. IN some examples, the system 100 may detect an utterance by performing audio processing and then perform active speaker detection to determine which user is speaking during the utterance.

FIG. 12B is a conceptual diagram illustrating an example of an utterance-based method for performing active speaker detection, according to embodiments of the present disclosure. As illustrated in FIG. 12B, in some examples the system 100 may perform utterance-based active speaker detection 1250 to determine which user is speaking. For example, the system 100 may perform audio processing 1252 to continuously process input audio data 1260 to detect an utterance boundary 1265. The utterance boundary 1265 may correspond to a beginning of the utterance, an ending of the utterance, and/or both a beginning and an ending of the utterance without departing from the disclosure.

After generating the utterance boundary 1265, the system 100 may perform active speaker detection 1254 to determine which user was speaking during the time window indicated by the utterance boundary 1265. For example, the system 100 may process input image data 1270 to generate selected image data 1275 that corresponds to the utterance boundary 1265. In some examples, the utterance boundary 1265 may only indicate a beginning of the utterance and the system 100 may continue generating the selected image data 1275 until the system 100 detects an ending of the utterance. However, the disclosure is not limited thereto and in other examples the utterance boundary 1265 may indicate both a beginning and an ending of the utterance and the system 100 may generate the selected image data 1275 corresponding to the entire utterance.

The system 100 may perform active speaker detection 1254 to the selected image data 1275 to generate label data, illustrated in FIG. 12B as label graph 1280. For example, the system 100 may perform the active speaker detection 1254 to determine first measurement data corresponding to a first user 5a and second measurement data corresponding to a second user 5b. The system 100 may determine a first variation associated with the first measurement data, determine a second variation associated with the second measurement data, and then compare the first variation to the second variation. Based on this comparison, the system 100 may generate the label data indicating whether the first user 5a is speaking or the second user 5b is speaking.

In some examples, the system 100 may generate an individual label for each video frame in the selected image data 1275, although the disclosure is not limited thereto. For example, the label graph 1280 illustrates an example in which the system 100 determines label data that includes a first label (e.g., Label0=First User 5a is speaking) for video frames that are associated with the first user 5a speaking and a second label (e.g., Label1=Second user 5b is speaking) for video frames that are associated with the second user 5b speaking. While FIG. 12B illustrates an example in which only two faces are detected in the selected image data 1275, the disclosure is not limited thereto and the system 100 may detect three or more faces represented in the selected image data 1275 without departing from the disclosure.

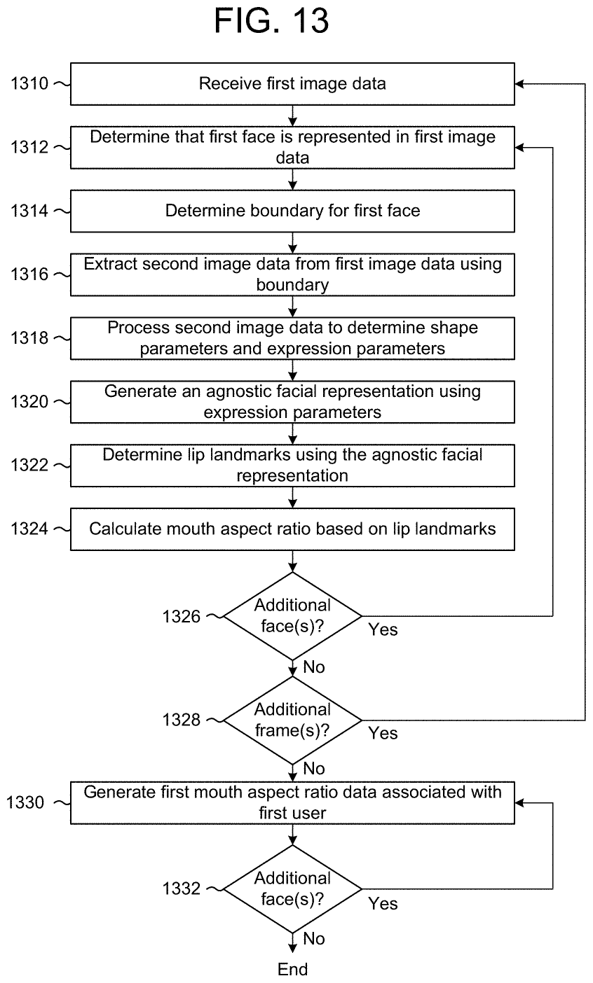

FIG. 13 is a flowchart conceptually illustrating an example method for generating mouth aspect ratio data, according to embodiments of the present disclosure. As illustrated in FIG. 13, the system 100 may receive (1310) first image data, determine (1312) that a first face is represented in the first image data, and determine (1314) a boundary for the first face. For example, the system 100 may detect a portion of the first image data that represents the face and determine a boundary that includes the portion of the first image data. Using the boundary, the system 100 may extract (1316) second image data from the first image data and process (1318) the second image data to determine shape parameters and expression parameters corresponding to the first face. As described above, the system 100 may process the second image data using a deep neural network (DNN) or other trained model that is configured to generate 3DMM parameters that include at least the expression parameters and the shape parameters. However, the disclosure is not limited thereto and in some examples the system 100 may input the first image data to the DNN or other trained model without departing from the disclosure.

Using the expression parameters, the system 100 may generate (1320) an agnostic facial representation and may determine (1322) lip landmarks using the agnostic facial representation. For example, the system 100 may generate a mesh model using only the expression parameters (e.g., ignoring the shape parameters and other portions of the 3DMM parameters) and may determine coordinate values corresponding to the lip landmarks within the mesh model, as described above with regard to FIG. 10A. After determining the lip landmarks and corresponding coordinate values, the system 100 may calculate (1324) a mouth aspect ratio based on the lip landmarks. For example, the system 100 may determine a first distance corresponding to a mouth height, a second distance corresponding to a mouth width, and determine the mouth aspect ratio value by dividing the first distance by the second distance. However, the disclosure is not limited thereto and the system 100 may determine the mouth aspect ratio using other techniques without departing from the disclosure.

While FIG. 13 illustrates an example of calculating a mouth aspect ratio based on lip landmarks, this is intended to conceptually illustrate a single example and the disclosure is not limited thereto. Thus, the system 100 may perform one or more facial measurements using lip landmarks and/or other facial landmarks without departing from the disclosure.

The system 100 may determine (1326) whether additional face(s) are represented in a current video frame of the first image data and, if so, may loop to step 1312 and repeat steps 1312-1326 for the additional face(s). If an additional face is not represented in the first image data, however, the system 100 may determine (1328) whether the first image data includes additional video frame(s). If the first image data includes additional video frame(s), the system 100 may loop to step 1310 and repeat steps 1310-1326 for the additional video frames.

If the first video data does not include additional video frame(s), the system 100 may generate (1330) first mouth aspect ratio data associated with the first user. For example, the system 100 may combine a series of mouth aspect ratio values for the first user over time to generate the first mouth aspect ratio data. The system 100 may determine (1332) whether there were additional face(s) detected in the first image data and, if so, may loop to step 1330 and repeat step 1330 for the additional face(s).

As described above with regard to FIGS. 12A-12B, the system 100 may perform active speaker detection using a frame-based method or an utterance-based method. In some examples, the system 100 may use the first mouth aspect ratio data to determine whether a user is speaking to detect an utterance, which corresponds to the frame-based method illustrated in FIG. 12A. In other examples, the system 100 may use first mouth aspect ratio data generated for a first user 5a and second mouth aspect ratio data generated for a second user 5b and determine whether the first user 5a or the second user 5b was speaking, which corresponds to the utterance-based method illustrated in FIG. 12B.

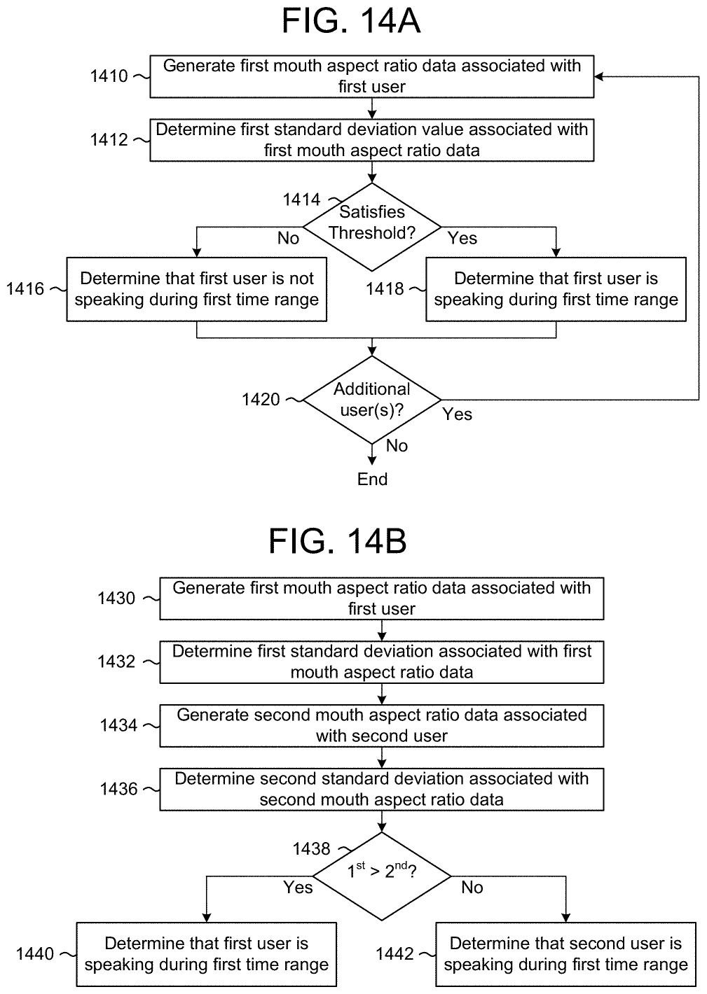

FIG. 14A is a flowchart conceptually illustrating an example of a frame-based method for performing active speaker detection to detect an utterance, according to embodiments of the present disclosure. As illustrated in FIG. 14A, the system 100 may generate (1410) first mouth aspect ratio data associated with a first user, may determine (1412) a first standard deviation value associated with the first mouth aspect ratio data, and may determine (1414) whether the first standard deviation value satisfies a threshold. If the first standard deviation value does not satisfy the threshold (e.g., is lower than a threshold value, exceeds a threshold value, is outside a desired range of threshold values, and/or the like), the system 100 may determine (1416) that the first user is not speaking during the first time range. If the first standard deviation value satisfies the threshold (e.g., exceeds the threshold value, is lower than the threshold value, is within a desired range of threshold values, and/or the like), the system 100 may determine (1418) that the first user is speaking during the first time range.

The system 100 may then determine (1420) whether there are additional user(s) represented in the image data and, if so, may loop to step 1410 and repeat steps 1410-1418 for the additional user(s). Thus, the system 100 may determine whether each individual user represented in the image data is speaking during the first time range. If the system 100 determines that a user was speaking, the system 100 may detect an utterance perform additional actions in response to detecting the utterance.

FIG. 14B is a flowchart conceptually illustrating an example of an utterance-based method for performing active speaker detection to identify a face associated with an utterance, according to embodiments of the present disclosure. As illustrated in FIG. 14B, the system 100 may generate (1430) first mouth aspect ratio data associated with the first user 5a, may determine (1432) a first standard deviation value associated with the first mouth aspect ratio data, may determine (1434) second mouth aspect ratio data associated with a second user 5b, may determine (1436) a second standard deviation value associated with the second mouth aspect ratio data, and determine (1438) whether the first standard deviation value is greater than the second standard deviation value.

If the first standard deviation value is greater than the second standard deviation value (e.g., indicating that the first mouth aspect ratio data has more variation, which may correspond to mouth movements such as speech), the system 100 may determine (1440) that the first user 5a is speaking during the first time range. However, if the first standard deviation value is less than the second standard deviation value (e.g., indicating that the second mouth aspect ratio data has more variation, which may correspond to mouth movements such as speech), the system 100 may determine (1442) that the second user 5b is speaking during the first time range.

While FIG. 14B illustrates a simple example involving two users, the disclosure is not limited thereto and the system 100 may compare standard deviation values between three or more users without departing from the disclosure. In addition, while FIGS. 14A-14B illustrate examples of generating mouth aspect ratio data, this is intended to conceptually illustrate a single example and the disclosure is not limited thereto. Thus, the system 100 may perform one or more facial measurements instead of determining the mouth aspect ratio data without departing from the disclosure. Additionally or alternatively, while FIGS. 14A-14B illustrate examples of determining a standard deviation value associated with mouth aspect ratio data, this is intended to conceptually illustrate a single example and the disclosure is not limited thereto. Instead, the system 100 may determine an amount of variation using other techniques without departing from the disclosure.

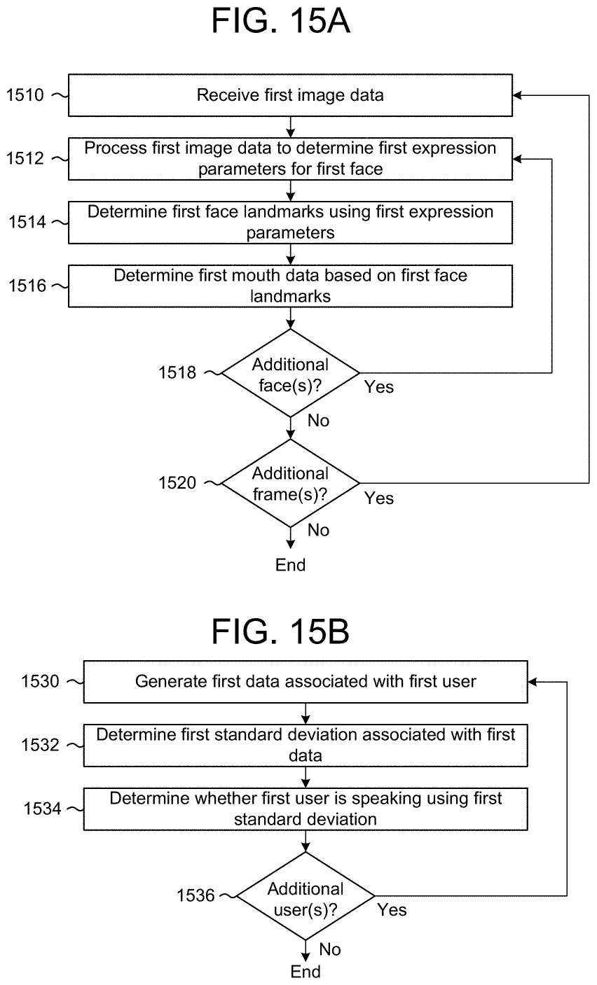

FIGS. 15A-15B are flowcharts conceptually illustrating example methods for determining mouth data and using the mouth data to determine whether a user is speaking, according to embodiments of the present disclosure. As illustrated in FIG. 15A, the system 100 may receive (1510) first image data and may process (1512) the first image data to determine first expression parameters for a first face represented in the first image data. For example, the system 100 may input the first image data to a DNN or other model to generate 3DMM parameters that include the first expression parameters.

Using the first expression parameters, the system 100 may determine (1514) first face landmarks and may determine (1516) first mouth data based on the first face landmarks. For example, the system 100 may use the first expression parameters to generate a mesh model having an agnostic facial representation and then perform facial measurements corresponding to the face landmarks associated with the agnostic facial representation. In some examples, the first mouth data may correspond to the facial measurements, while in other examples the first mouth data may correspond to an amount of variation (e.g., standard deviation, variance, and/or the like) present in the facial measurements without departing from the disclosure. As described above with regard to FIG. 10A, the face landmarks may correspond to lip landmarks (e.g., top, bottom, left, and right), although the disclosure is not limited thereto and the face landmarks may correspond to other positions on the face without departing from the disclosure

The system 100 may determine (1518) whether there are additional face(s) represented in the first image data, and if so, may loop to step 1512 and repeat steps 1512-1518 for the additional face(s). If there are no additional face(s) represented in the first image data, the system 100 may determine (1520) whether there are additional video frame(s) included in the first image data, and if so, may loop to step 1510 and repeat steps 1510-1518 for the additional video frame(s). Thus, the system 100 may determine mouth data for each of the faces represented in the first image data.

As illustrated in FIG. 15B, the system 100 may generate (1530) first data associated with a first user. For example, the system 100 may generate first data corresponding to mouth aspect ratio data and/or other facial measurements, although the disclosure is not limited thereto. The system 100 may determine (1532) a first standard deviation value associated with the first data and may determine (1534) whether the first user is speaking using the first standard deviation value. For example, the system 100 may determine whether the first standard deviation value satisfies a threshold and, if so, may generate a label indicating that the first user is speaking during a corresponding time window (e.g., time interval).

The system 100 may determine (1536) whether additional user(s) are represented in the first image data and may loop to step 1530 and repeat steps 1530-1536 for the additional user(s). Thus, the system 100 may determine whether each user represented in the first image data is speaking, determine a time window during which an individual user is speaking, generate label data indicating whether each user is speaking, and/or the like without departing from the disclosure.

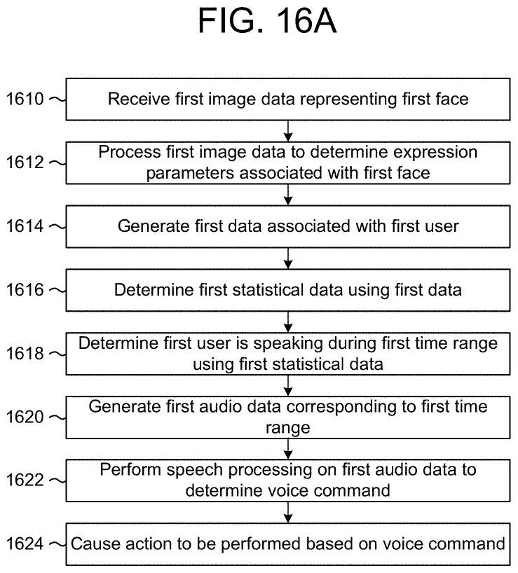

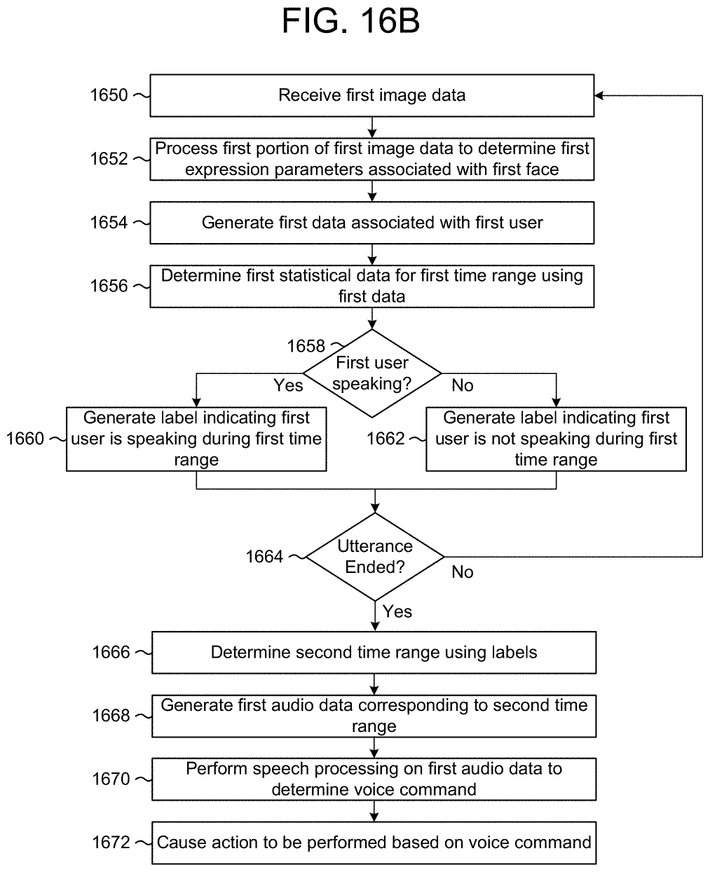

FIGS. 16A-16B are flowcharts conceptually illustrating example methods for performing active speaker detection to detect an utterance and perform speech processing, according to embodiments of the present disclosure. As illustrated in FIG. 16A, the system 100 may receive (1610) first image data representing a first face and may process (1612) the first image data to determine expression parameters associated with the first face. For example, the system 100 may input the first image data to a deep neural network (DNN) or other trained model to generate 3DMM parameters that include the expression parameters, as described in greater detail above with regard to FIGS. 7-10B.

The system 100 may generate (1614) first data associated with the first user and determine (1616) first statistical data using the first data. For example, the system 100 may generate first data representing facial measurements such as positions of facial landmarks, a mouth height, a mouth width, a mouth aspect ratio, and/or the like, as described in greater detail above with regard to FIGS. 14A-14B. The system 100 may then determine the first statistical data representing an amount of variation in the first data, such as by determining a standard deviation, variance, and/or the like.

The system 100 may determine (1618) that a first user is speaking during a first time range using the first statistical data. For example, the system 100 may detect an utterance based on the first statistical data satisfying a threshold. In some examples, the system 100 may generate label data indicating whether the first user is speaking for individual video frames of the first image data, although the disclosure is not limited thereto.

In response to determining that the first user is speaking during the first time range, the system 100 may generate (1620) first audio data corresponding to the first time range, may perform (1622) speech processing on the first audio data to determine a voice command, and may cause (1624) an action to be performed based on the voice command, as described in greater detail above with regard to FIGS. 2-3.

As illustrated in FIG. 16B, the system 100 may receive (1650) first image data, may process (1652) a first portion of the first image data to determine first expression parameters associated with a first face, may generate (1654) first data associated with the first user, and may determine (1656) first statistical data for a first time range using the first data, as described above with regard to FIG. 16A.

The system 100 may use the first statistical data to determine (1658) whether the first user is speaking. If the system 100 determines that the first user is speaking, the system 100 may generate (1660) a first label indicating that the first user is speaking during a first time range corresponding to the first portion of the first image data (e.g., individual video frame, series of video frames, etc.). If the system 100 determines that the first user is not speaking, the system 100 may generate (1662) a second label indicating that the first user is not speaking during the first time range corresponding to the first portion of the first image data (e.g., individual video frame, series of video frames, etc.). The system 100 may determine (1664) whether the utterance has ended and, if not, may loop to step 1650 and repeat steps 1650-1662.

If the system 100 determines that the utterance has ended, the system 100 may determine (1666) a second time range using the labels (e.g., label data), may generate (1668) first audio data corresponding to the second time range, may perform (1670) speech processing on the first audio data to determine a voice command, and may cause (1672) an action to be performed based on the voice command, as described in greater detail above with regard to FIGS. 2-3.

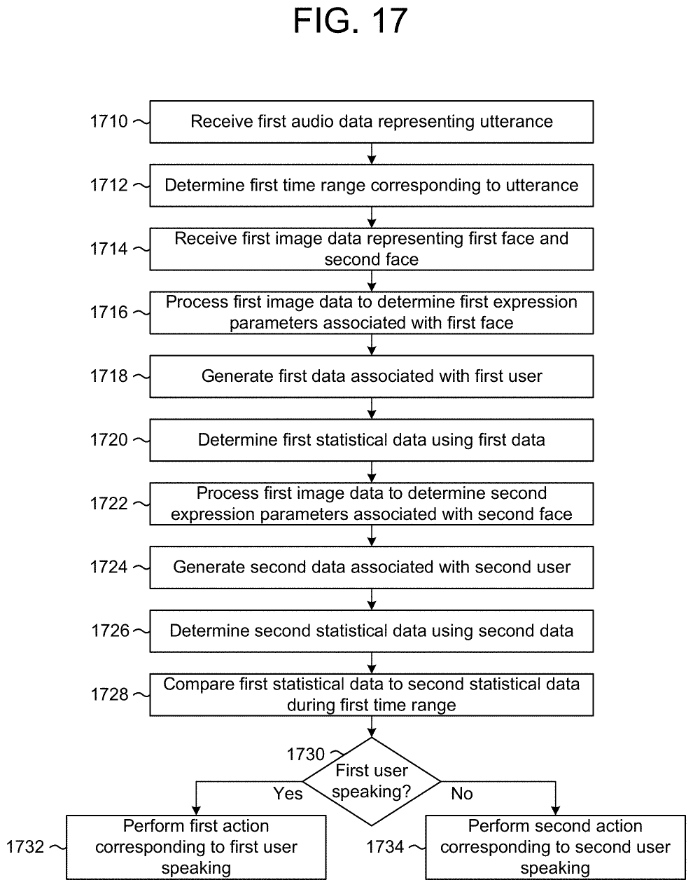

FIG. 17 is a flowchart conceptually illustrating an example method for performing active speaker detection to determine which user is speaking and perform an action, according to embodiments of the present disclosure. As illustrated in FIG. 17, the system 100 may receive (1710) first audio data representing an utterance and may determine (1712) a first time range corresponding to the utterance.

The system 100 may receive (1714) first image data representing a first face and a second face that corresponds to the first time range. The system 100 may process (1716) the first image data to determine first expression parameters associated with the first face, may generate (1718) first data associated with a first user corresponding to the first face, and may determine (1720) first statistical data using the first data, as described in greater detail above with regard to FIGS. 7-10B. Similarly, the system 100 may process (1722) the first image data to determine second expression parameters associated with the second face, may generate (1724) second data associated with a second user corresponding to the second face, and may determine (1726) second statistical data using the second data.

The system 100 may compare (1728) the first statistical data to the second statistical data during the first time range and determine (1730) the first user is speaking. If the system 100 determines that the first user is speaking, the system 100 may perform (1732) a first action corresponding to the first user speaking. For example, the system 100 may generate audio data corresponding to the utterance, may move and/or rotate the device in the direction of the first user, and/or the like without departing from the disclosure. If the system 100 determines that the first user is not speaking, however, the system 100 may determine that the second user is speaking and may perform (1734) a second action corresponding to the second user speaking. For example, the system 100 may generate audio data corresponding to the utterance, may move and/or rotate the device in the direction of the second user, and/or the like without departing from the disclosure.

While FIG. 17 illustrates an example of performing active speaker detection to determine whether the first user or the second user is speaking, the disclosure is not limited thereto and the system 100 may perform active speaker detection to determine whether three or more users are speaking without departing from the disclosure.

Various machine learning techniques may be used to train and operate models to perform various steps described herein, such as user recognition, sentiment detection, image processing, dialog management, etc. Models may be trained and operated according to various machine learning techniques. Such techniques may include, for example, neural networks (such as deep neural networks and/or recurrent neural networks), inference engines, trained classifiers, etc. Examples of trained classifiers include Support Vector Machines (SVMs), neural networks, decision trees, AdaBoost (short for “Adaptive Boosting”) combined with decision trees, and random forests. Focusing on SVM as an example, SVM is a supervised learning model with associated learning algorithms that analyze data and recognize patterns in the data, and which are commonly used for classification and regression analysis. Given a set of training examples, each marked as belonging to one of two categories, an SVM training algorithm builds a model that assigns new examples into one category or the other, making it a non-probabilistic binary linear classifier. More complex SVM models may be built with the training set identifying more than two categories, with the SVM determining which category is most similar to input data. An SVM model may be mapped so that the examples of the separate categories are divided by clear gaps. New examples are then mapped into that same space and predicted to belong to a category based on which side of the gaps they fall on. Classifiers may issue a “score” indicating which category the data most closely matches. The score may provide an indication of how closely the data matches the category.

In order to apply the machine learning techniques, the machine learning processes themselves need to be trained. Training a machine learning component such as, in this case, one of the first or second models, requires establishing a “ground truth” for the training examples. In machine learning, the term “ground truth” refers to the accuracy of a training set's classification for supervised learning techniques. Various techniques may be used to train the models including backpropagation, statistical learning, supervised learning, semi-supervised learning, stochastic learning, or other known techniques.

FIG. 18 is a block diagram conceptually illustrating a device 110 that may be used with the system. FIG. 19 is a block diagram conceptually illustrating example components of a remote device, such as the natural language command processing system 120, which may assist with ASR processing, NLU processing, etc., and a skill system 125. A system (120/125) may include one or more servers. A “server” as used herein may refer to a traditional server as understood in a server/client computing structure but may also refer to a number of different computing components that may assist with the operations discussed herein. For example, a server may include one or more physical computing components (such as a rack server) that are connected to other devices/components either physically and/or over a network and is capable of performing computing operations. A server may also include one or more virtual machines that emulates a computer system and is run on one or across multiple devices. A server may also include other combinations of hardware, software, firmware, or the like to perform operations discussed herein. The server(s) may be configured to operate using one or more of a client-server model, a computer bureau model, grid computing techniques, fog computing techniques, mainframe techniques, utility computing techniques, a peer-to-peer model, sandbox techniques, or other computing techniques.

Multiple systems (120/125) may be included in the overall system 100 of the present disclosure, such as one or more natural language processing systems 120 for performing ASR processing, one or more natural language processing systems 120 for performing NLU processing, one or more skill systems 125, etc. In operation, each of these systems may include computer-readable and computer-executable instructions that reside on the respective device (120/125), as will be discussed further below.

System 120 may be a remote system such as a cloud system that operates at a location not proximate to device 110. System 120 may also be a system that operates at a similar location to device 110, though perhaps in a different physical device such as a home server, edge server, or the like. System 120 may also be a distributed system where certain components/operations occur using device(s) at one location and other components/operations occur using device(s) at another location.

Each of these devices (110/120/125) may include one or more controllers/processors (1804/1904), which may each include a central processing unit (CPU) for processing data and computer-readable instructions, and a memory (1806/1906) for storing data and instructions of the respective device. The memories (1806/1906) may individually include volatile random access memory (RAM), non-volatile read only memory (ROM), non-volatile magnetoresistive memory (MRAM), and/or other types of memory. Each device (110/120/125) may also include a data storage component (1808/1908) for storing data and controller/processor-executable instructions. Each data storage component (1808/1908) may individually include one or more non-volatile storage types such as magnetic storage, optical storage, solid-state storage, etc. Each device (110/120/125) may also be connected to removable or external non-volatile memory and/or storage (such as a removable memory card, memory key drive, networked storage, etc.) through respective input/output device interfaces (1802/1902).

Computer instructions for operating each device (110/120/125) and its various components may be executed by the respective device's controller(s)/processor(s) (1804/1904), using the memory (1806/1906) as temporary “working” storage at runtime. A device's computer instructions may be stored in a non-transitory manner in non-volatile memory (1806/1906), storage (1808/1908), or an external device(s). Alternatively, some or all of the executable instructions may be embedded in hardware or firmware on the respective device in addition to or instead of software.

Each device (110/120/125) includes input/output device interfaces (1802/1902). A variety of components may be connected through the input/output device interfaces (1802/1902), as will be discussed further below. Additionally, each device (110/120/125) may include an address/data bus (1824/1924) for conveying data among components of the respective device. Each component within a device (110/120/125) may also be directly connected to other components in addition to (or instead of) being connected to other components across the bus (1824/1924).

Referring to FIG. 18, the device 110 may include input/output device interfaces 1802 that connect to a variety of components such as an audio output component such as a speaker 1812, a wired headset or a wireless headset (not illustrated), or other component capable of outputting audio. The device 110 may also include an audio capture component. The audio capture component may be, for example, a microphone 1820 or array of microphones, a wired headset or a wireless headset (not illustrated), etc. If an array of microphones is included, approximate distance to a sound's point of origin may be determined by acoustic localization based on time and amplitude differences between sounds captured by different microphones of the array. An array of microphones may also be used to perform beamforming/other techniques to determine a direction of a sound's point of origin relative to the device 110. Data from the array of microphones as well as other components may be used to track a sound's source as it moves around an environment of a device 110. The device 110 may additionally include a display 1816 for displaying content. The device 110 may further include a camera 1818.

Via antenna(s) 1822, the input/output device interfaces 1802 may connect to one or more networks 199 via a wireless local area network (WLAN) (such as WiFi) radio, Bluetooth, and/or wireless network radio, such as a radio capable of communication with a wireless communication network such as a Long Term Evolution (LTE) network, WiMAX network, 3G network, 4G network, 5G network, etc. A wired connection such as Ethernet may also be supported. Through the network(s) 199, the system may be distributed across a networked environment. The I/O device interface (1802/1902) may also include communication components that allow data to be exchanged between devices such as different physical servers in a collection of servers or other components.

The components of the device(s) 110, the natural language command processing system 120, or a skill system 125 may include their own dedicated processors, memory, and/or storage. Alternatively, one or more of the components of the device(s) 110, the natural language command processing system 120, or a skill system 125 may utilize the I/O interfaces (1802/1902), processor(s) (1804/1904), memory (1806/1906), and/or storage (1808/1908) of the device(s) 110, natural language command processing system 120, or the skill system 125, respectively. Thus, the ASR component 250 may have its own I/O interface(s), processor(s), memory, and/or storage; the NLU component 260 may have its own I/O interface(s), processor(s), memory, and/or storage; and so forth for the various components discussed herein.

As noted above, multiple devices may be employed in a single system. In such a multi-device system, each of the devices may include different components for performing different aspects of the system's processing. The multiple devices may include overlapping components. The components of the device 110, the natural language command processing system 120, and a skill system 125, as described herein, are illustrative, and may be located as a stand-alone device or may be included, in whole or in part, as a component of a larger device or system.

As illustrated in FIG. 20, multiple devices (110a-110n, 120, 125) may contain components of the system and the devices may be connected over a network(s) 199. The network(s) 199 may include a local or private network or may include a wide network such as the Internet. Devices may be connected to the network(s) 199 through either wired or wireless connections. For example, a speech-detection device 110a, a smart phone 110b, a smart watch 110c, a tablet computer 110d, a vehicle 110e, a display device 110f, a smart television 110g, a washer/dryer 110h, a refrigerator 110i, and/or a microwave 110j may be connected to the network(s) 199 through a wireless service provider, over a WiFi or cellular network connection, or the like. Other devices are included as network-connected support devices, such as the natural language command processing system 120, the skill system(s) 125, and/or others. The support devices may connect to the network(s) 199 through a wired connection or wireless connection. Networked devices may capture audio using one-or-more built-in or connected microphones or other audio capture devices, with processing performed by ASR components, NLU components, or other components of the same device or another device connected via the network(s) 199, such as the ASR component 250, the NLU component 260, etc. of the natural language command processing system 120.

The concepts disclosed herein may be applied within a number of different devices and computer systems, including, for example, general-purpose computing systems, speech processing systems, and distributed computing environments.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. Persons having ordinary skill in the field of computers and speech processing should recognize that components and process steps described herein may be interchangeable with other components or steps, or combinations of components or steps, and still achieve the benefits and advantages of the present disclosure. Moreover, it should be apparent to one skilled in the art, that the disclosure may be practiced without some or all of the specific details and steps disclosed herein. Further, unless expressly stated to the contrary, features/operations/components, etc. from one embodiment discussed herein may be combined with features/operations/components, etc. from another embodiment discussed herein.

Aspects of the disclosed system may be implemented as a computer method or as an article of manufacture such as a memory device or non-transitory computer readable storage medium. The computer readable storage medium may be readable by a computer and may comprise instructions for causing a computer or other device to perform processes described in the present disclosure. The computer readable storage medium may be implemented by a volatile computer memory, non-volatile computer memory, hard drive, solid-state memory, flash drive, removable disk, and/or other media. In addition, components of system may be implemented as in firmware or hardware.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements, and/or steps are in any way required for one or more embodiments or that one or more embodiments necessarily include logic for deciding, with or without other input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

As used in this disclosure, the term “a” or “one” may include one or more items unless specifically stated otherwise. Further, the phrase “based on” is intended to mean “based at least in part on” unless specifically stated otherwise.

What is claimed is:

1. A computer-implemented method, the method comprising:
receiving first image data;
determining that a first face is represented in a first portion of the first image data;
inputting the first portion of the first image data to a trained model to determine first data representing at least one first parameter corresponding to a first facial expression;
using the first data to generate second data including a first agnostic facial representation having the first facial expression, the first agnostic facial representation having uniform identity and uniform pose;
using the second data to determine third data representing a first width of a first mouth in the first agnostic facial representation;
using the second data to determine fourth data representing a first height of the first mouth;
using the third data and the fourth data to determine a portion of fifth data representing a first ratio between the first height of the first mouth and the first width of the first mouth, the fifth data representing a first series of ratio values;
determining a first standard deviation value using the first series of ratio values represented in the fifth data;
determining that the first standard deviation value exceeds a threshold value; and
in response to determining that the first standard deviation value exceeds the threshold value, determining that a user associated with the first face is speaking.

2. The computer-implemented method of claim 1, wherein determining that the user is speaking further comprises detecting a beginning of an utterance during a first time interval, the method further comprising:
generating audio data representing the utterance, a beginning of the audio data occurring within the first time interval;
causing speech processing to be performed to the audio data; and
in response to the speech processing, causing an action to be performed corresponding to the utterance.

3. The computer-implemented method of claim 1, further comprising:
detecting an utterance;
determining a first time interval extending from a beginning of the utterance to an ending of the utterance;
determining that a second face is represented in a second portion of the first image data;
determining a portion of sixth data representing a second ratio between a second height of a second mouth in a second agnostic facial representation corresponding to the second face and a second width of the second mouth, the sixth data representing a second series of ratio values;
determining a second standard deviation value using the second series of ratio values represented in the sixth data;
determining a first portion of seventh data indicating that the first standard deviation value is greater than the second standard deviation value; and
using the seventh data to determine that the first face is more likely to be speaking than the second face during the first time interval.

4. A computer-implemented method, the method comprising:
receiving first image data;
determining that a first face is represented in the first image data;
processing the first image data to determine first data representing at least one first parameter corresponding to a first facial expression;
using the first data to generate second data that includes a portion of a first agnostic facial representation representing a first mouth;
using the second data to determine a portion of third data representing a first ratio value between a first mouth height of the first mouth and a first mouth width of the first mouth, the third data including a first plurality of ratio values;
determining fourth data representing a first amount of variation in the first plurality of ratio values; and
using the fourth data to determine that the first face is speaking.

5. The computer-implemented method of claim 4, wherein
determining the fourth data further comprises determining a standard deviation value associated with the first plurality of ratio values, and using the fourth data to determine that the first face is speaking further comprises:
determining that the standard deviation value satisfies a threshold; and
in response to determining that the standard deviation value satisfies the threshold, determining that a user associated with the first face is speaking.

6. The computer-implemented method of claim 4, wherein using the second data to determine the portion of the third data further comprises:
using the second data to determine first coordinate values corresponding to a top lip of the first mouth;
using the second data to determine second coordinate values corresponding to a bottom lip of the first mouth;
using the first coordinate values and the second coordinate values to determine the first mouth height;
using the second data to determine third coordinate values corresponding to a first intersection between the top lip and the bottom lip in the first agnostic facial representation;
using the second data to determine fourth coordinate values corresponding to a second intersection between the top lip and the bottom lip in the first agnostic facial representation;
using the third coordinate values and the fourth coordinate values to determine the first mouth width; and
determining the portion of the third data by determining the first ratio value between the first mouth height and the first mouth width.

7. The computer-implemented method of claim 4, wherein using the fourth data to determine that the first face is speaking further comprises using the fourth data to detect a beginning of an utterance during a first time interval, the method further comprising:
generating first audio data representing the utterance, a beginning of the first audio data corresponding to the first time interval;
causing speech processing to be performed on the first audio data; and
in response to the speech processing, causing an action to be performed corresponding to the utterance.

8. The computer-implemented method of claim 4, further comprising:
determining that a second face is represented in the first image data;
processing the first image data to determine fifth data representing at least one second parameter corresponding to a second facial expression;
using the fifth data to generate sixth data that includes a portion of a second agnostic facial representation representing a second mouth;
using the sixth data to determine a portion of seventh data representing a second ratio value between a second mouth height of the second mouth and a second mouth width of the second mouth, the seventh data including a second plurality of ratio values; and
determining eighth data representing a second amount of variation in the second plurality of ratio values,
wherein using the fourth data to determine that the first face is speaking further comprises:
determining that the first amount of variation is greater than the second amount of variation; and
determining that the first face is speaking.

9. The computer-implemented method of claim 8, further comprising:
generating audio data;
detecting an utterance represented in the audio data; and
determining a first time interval extending from a beginning of the utterance to an ending of the utterance,
wherein using the fourth data to determine that the first face is speaking further comprises:
using the fourth data and the eighth data to determine that the first face is more likely to be speaking than the second face during the first time interval; and
determining that the first face is speaking.

10. The computer-implemented method of claim 4, further comprising:
receiving second image data following the first image data, the second image data corresponding to a first time interval;
determining that the first face is represented in the second image data;
processing the second image data to determine fifth data representing at least one second parameter corresponding to a second facial expression;
using the fifth data to generate sixth data that includes a portion of a second agnostic facial representation representing a second mouth;
using the sixth data to determine a portion of seventh data representing a second ratio value between a second mouth height of the second mouth and a second mouth width of the second mouth, the seventh data including a second plurality of ratio values;
determining eighth data representing a second amount of variation in the second plurality of ratio values; and
using the eighth data to determine that the first face is not speaking during the first time interval.

11. The computer-implemented method of claim 4, further comprising:
determining that a second face is represented in the first image data;
processing the first image data to determine fifth data representing at least one second parameter corresponding to a second facial expression;
using the fifth data to generate sixth data that includes a portion of a second agnostic racial representation representing a second mouth;
using the sixth data to determine seventh data representing a second ratio value between a second mouth height of the second mouth and a second mouth width of the second mouth, the seventh data including a second plurality of ratio values;
determining eighth data representing a second amount of variation in the second plurality of ratio values; and
using the eighth data to determine that the second face is not speaking.

12. The computer-implemented method of claim 4, further comprising:
detecting an utterance;
determining a first time interval extending from a beginning of the utterance to an ending of the utterance;
determining that a second face is represented in the first image data;
determining a portion of fifth data representing a second ratio value between a second height of a second mouth in a second agnostic facial representation corresponding to the second face and a second width of the second mouth, the fifth data representing a second series of ratio values;
determining a second standard deviation value using the second series of ratio values represented in the fifth data;
determining a first portion of sixth data indicating that the first standard deviation value is greater than the second standard deviation value; and
using the fourth data and the sixth data to determine that the first face is more likely to be speaking than the second face during the first time interval.

13. A system comprising:
at least one processor; and
memory including instructions operable to be executed by the at least one processor to cause the system to:
receive first image data;
determine that a first face is represented in the first image data;
process the first image data to determine first data representing at least one first parameter corresponding to a first facial expression;
use the first data to generate second data that includes a portion of a first agnostic facial representation representing a first mouth;
use the second data to determine a portion of third data representing a first ratio value between a first mouth height of the first mouth and a first mouth width of the first mouth, the third data including a first plurality of ratio values;
determine fourth data representing a first amount of variation in the first plurality of ratio values; and
use the fourth data to determine that the first face is speaking.

14. The system of claim 13, wherein the memory further comprises instructions that, when executed by the at least one processor, further cause the system to:
determine a standard deviation value associated with the first plurality of ratio values;
determine that the standard deviation value satisfies a threshold; and
in response to determining that the standard deviation value satisfies the threshold, determine that a user associated with the first face is speaking.

15. The system of claim 13, wherein the memory further comprises instructions that, when executed by the at least one processor, further cause the system to:
use the second data to determine first coordinate values corresponding to a top lip of the first mouth;
use the second data to determine second coordinate values corresponding to a bottom lip of the first mouth;
use the first coordinate values and the second coordinate values to determine the first mouth height;
use the second data to determine third coordinate values corresponding to a first intersection between the top lip and the bottom lip in the first agnostic facial representation;
use the second data to determine fourth coordinate values corresponding to a second intersection between the top lip and the bottom lip in the first agnostic facial representation;
use the third coordinate values and the fourth coordinate values to determine the first mouth width; and
determine the portion of the third data by determining the first ratio value between the first mouth height and the first mouth width.

16. The system of claim 13, wherein the memory further comprises instructions that, when executed by the at least one processor, further cause the system to:
use the fourth data to detect a beginning of an utterance during a first time interval;
generate first audio data representing the utterance, a beginning of the first audio data corresponding to the first time interval;
cause speech processing to be performed on the first audio data; and
in response to the speech processing, cause an action to be performed corresponding to the utterance.

17. The system of claim 13, wherein the memory further comprises instructions that, when executed by the at least one processor, further cause the system to:
determine that a second face is represented in the first image data;
process the first image data to determine fifth data representing at least one second parameter corresponding to a second facial expression;
use the fifth data to generate sixth data that includes a portion of a second agnostic facial representation representing a second mouth;
use the sixth data to determine a portion of seventh data representing a second ratio value between a second mouth height of the second mouth and a second mouth width of the second mouth, the seventh data including a second plurality of ratio values;
determine eighth data representing a second amount of variation in the second plurality of ratio values;
determine that the first amount of variation is greater than the second amount of variation; and
determine that the first face is speaking.

18. The system of claim 17, wherein the memory further comprises instructions that, when executed by the at least one processor, further cause the system to:
generate audio data;
detect an utterance represented in the audio data;
determine a first time interval extending from a beginning of the utterance to an ending of the utterance;
using the fourth data and the eighth data to determine that the first face is more likely to be speaking than the second face during the first time interval; and
determining that the first face is speaking.

19. The system of claim 13, wherein the memory further comprises instructions that, when executed by the at least one processor, further cause the system to:
receive second image data following the first image data, the second image data corresponding to a first time interval;
determine that the first face is represented in the second image data;
process the second image data to determine fifth data representing at least one second parameter corresponding to a second facial expression;
use the fifth data to generate sixth data that includes a portion of a second agnostic facial representation representing a second mouth;
use the sixth data to determine a portion of seventh data representing a second ratio value between a second mouth height of the second mouth and a second mouth width of the second mouth, the seventh data including a second plurality of ratio values;
determine eighth data representing a second amount of variation in the second plurality of ratio values; and
use the eighth data to determine that the first face is not speaking during the first time interval.

20. The system of claim 13, wherein the memory further comprises instructions that, when executed by the at least one processor, further cause the system to:
determine that a second face is represented in the first image data;
process the first image data to determine fifth data representing at least one second parameter corresponding to a second facial expression;
use the fifth data to generate sixth data that includes a portion of a second agnostic racial representation representing a second mouth;
use the sixth data to determine seventh data representing a second ratio value between a second mouth height of the second mouth and a second mouth width of the second mouth, the seventh data including a second plurality of ratio values;
determine eighth data representing a second amount of variation in the second plurality of ratio values; and
use the eighth data to determine that the second face is not speaking.
